(19) United States
(12) Patent Application Publication
(10) Pub. No.: US 2011/0196570 A1
(43) Pub. Date: Aug. 11, 2011

(54) STARTER CONTROLLER

(75) Inventor: Ryouta NAKAMURA, Handa-city (JP)

(73) Assignee: DENSO CORPORATION, Kariya-city (JP)

(21) Appl. No.: 13/023,711

(22) Filed: Feb. 9, 2011

(30) Foreign Application Priority Data
Feb. 10, 2010 (JP) 2010-27708
Jul. 9, 2010 (JP) 2010-156754

(51) Int. Cl. F02N 11/08; G06F 19/00

(52) U.S. Cl. 701/29; 123/179.3; 701/113

(57) ABSTRACT

An idle reduction vehicle has a relay in a power supply line from a battery to a starter motor. The relay is driven between a contact-side state, in which contacts short-circuit, and a resistor-side state, in which the contacts are opened and a resistor is serially inserted into the power supply line. At an engine restart from idle reduction, an ECU drives the relay to the resistor-side state and starts energization to the motor, thereby suppressing an inrush current. The ECU detects a contact-side state fixation abnormality of the relay based on a battery voltage at the time when the ECU drives the relay to the resistor-side state and energizes the motor. The ECU detects a resistor-side state fixation abnormality of the relay based on the battery voltage at the time when the ECU drives the relay to the contact-side state and energizes the motor.

### CROSS REFERENCE TO RELATED APPLICATION

This application is based on and incorporates herein by reference Japanese Patent Applications No. 2010-27708 filed on Feb. 10, 2010 and No. 2010-156754 filed on Jul. 9, 2010.

### BACKGROUND OF THE INVENTION

1. Field of the Invention

The present invention relates to a controller of a starter that cranks an engine of a vehicle to start the engine.

2. Description of Related Art

In recent years, a vehicle (automobile) having an engine automatic stop-start system is practically used, for example, as described in Patent document 1 (JP-A-H11-30139). Generally, the engine automatic stop-start system is called an idle reduction system or an idling reduction system. The engine automatic stop-start system automatically stops an engine if a predetermined stop condition is satisfied. Thereafter, the engine automatic stop-start system automatically starts the engine if a predetermined start condition is satisfied.

Patent document 2 (JP-A-2009-185760) describes providing an inrush current reduction relay for suppressing an inrush current flowing to a starter motor, which cranks an engine, in a power supply line used for energizing the starter motor in an idle reduction system. In Patent document 2, the inrush current reduction relay is called an auxiliary switch incorporating a resistor. The inrush current reduction relay has a pair of contacts, which are opened and closed according to deenergization and energization of an electromagnetic coil, and a resistor connected in parallel to the contacts. According to Patent document 2, the contacts of the inrush current reduction relay are opened when the energization to the starter motor is started. Thus, a current suppressed by the resistor is passed to the starter motor. Thereafter, the contacts are closed resistor is bypassed) to apply a full voltage of a battery to the starter motor. By such the control, the inrush current as of the start of the energization to the starter motor is suppressed. Thus, fall of a power supply voltage (i.e., battery voltage) is inhibited, and operations of electric devices of the vehicle are secured.

Specifically, automatic stop and automatic start of the engine are performed when a vehicle having an idle reduction system (hereafter, referred to as idle reduction vehicle) is in a running state (including a state where vehicle speed is zero). Therefore, if a controller in the vehicle is reset by the fall of the power supply voltage at the automatic start, the controller is reset during the running. Such the situation should be avoided. Therefore, the construction equipped with the above-mentioned inrush current reduction relay is used.

However, even in the case of the idle reduction vehicle, the energization to the starter motor should be performed while closing the contacts of the inrush current reduction relay from the beginning when the engine is started by a starting operation by a vehicle driver. The starting operation is manipulation to twist a key or manipulation to push a start switch, for example. The reason is as follows. That is, the engine start performed by the starting operation of the vehicle driver is an engine start before the vehicle starts running, i.e., an engine start not during the running. Such the engine start is an engine start performed from a state where an ignition system power supply of the vehicle (i.e., power supply of device mainly performing control related to running) is in an off-state. Therefore, there is no problem even if any controller is reset by the fall of the power supply voltage accompanying the energization to the starter motor. Rather, it is desirable to prioritize quick engine start without suppressing the energization current to the starter motor.

Patent document 1 describes the starter constructed to be able to switch between a state where a pinion gear rotated by a motor is engaged with a ring gear of the engine and a state where the pinion gear is disengaged from the ring gear regardless of energization to the motor. The pinion gear rotates the ring gear of the engine to crank the engine if the pinion gear is rotated by the starter motor while the pinion gear is engaged with the ring gear. A solenoid for moving the pinion gear to engage the pinion gear with the ring gear of the engine and a relay for energizing the starter motor are provided separately. According to Patent document 1, after the engine stops automatically because of the function of the idle reduction system, the solenoid is energized to engage the pinion gear with the ring gear of the engine. When the engine is started, the starter motor is energized in the state where the pinion gear and the ring gear have been already engaged with each other, thereby cranking the engine. With such the operation, wear caused between the pinion gear of the starter and the ring gear of the engine is reduced and a noise caused when the pinion gear and the ring gear engage with each other is reduced.

If a fixation abnormality occurs in the inrush current reduction relay and the contacts remain closed in the construction described in Patent document 2, the resistor cannot be effected in the restart of the engine from the idle reduction state. That is, there is a possibility that the inrush current to the starter motor cannot be suppressed in the restart of the engine, so the power supply voltage falls and a certain controller in the vehicle is reset. For example, if a controller that controls the starter or fuel injection to the engine is reset, a problem that the restart of the engine takes a long time is anticipated. For example, if a device that controls an air-conditioner is reset, a problem that temperature setting of the air-conditioner returns to an initial value is anticipated.

If the contacts remain opened, the resistor continues to exist in the power supply line to the starter motor. In this case, power consumption and heat generation in the resistor during the energization to the starter motor (i.e., during engine start) become very large. If the resistor is cut by the heat generation, the energization to the starter motor is no longer possible, disabling the engine start.

Therefore, it is desirable to detect occurrence of the fixation abnormality of the inrush current reduction relay and to perform some treatment.

### SUMMARY OF THE INVENTION

It is an object of the present invention to enable detection of an uncontrollable abnormality in an inrush current suppressing section that suppresses an inrush current flowing to a starter motor.

According to a first example aspect of the present invention, a vehicle using a starter controller has a starter for cranking an engine of the vehicle by using torque of a motor, a switching section, an inrush current suppressing section, and an idle reduction controlling section.

The switching section is provided in a power supply line extending from a power supply to the motor of the starter (hereinafter, referred to as starter motor). The switching section is selectively driven between an on-state, in which the switching section connects the power supply line, and an off-state, in which the switching section blocks the power supply line. The inrush current suppressing section is provided in the power supply line in series with the switching section. The inrush current suppressing section is driven between a first state, in which the current passed to the starter motor is suppressed, and a second state, in which the current passed to the starter motor is not suppressed.

Therefore, if the switching section is in the off-state, the current does not flow through the starter motor. If the switching section is driven to the on-state and the inrush current suppressing section is driven to the first state, the current suppressed by the inrush current suppressing section flows from the power supply to the starter motor. If the switching section is driven to the on-state and the inrush current suppressing section is driven to the second state, the current not suppressed by the inrush current suppressing section flows from the power supply to the starter motor.

The idle reduction controlling section stops the engine when a predetermined automatic stop condition is satisfied. Thereafter, the idle reduction controlling section restarts the engine when a predetermined start condition is satisfied.

When the idle reduction controlling section restarts the engine, the starter controller according to the first example aspect of the present invention performs restart energization processing for driving the inrush current suppressing section to the first state, for driving the switching section to the on-state, and for driving the inrush current suppressing section from the first state to the second state after elapse of a predetermined time as energization processing for energizing the starter motor such that the starter cranks the engine. With such the processing, the current to the starter motor is suppressed by the inrush current suppressing section while the predetermined time elapses after the energization is started. As a result, the inrush current is suppressed and a large decrease of the power supply voltage can be prevented.

The starter controller has an abnormality detecting section that detects occurrence of an uncontrollable abnormality in the inrush current suppressing section based on a voltage of the power supply line at the time when the switching section is driven to the on-state.

If the switching section is in the on-state, the current that flows from the power supply to the starter motor takes different values according to a state of the inrush current suppressing section. If the current flowing through the starter motor differs, the voltage of the power supply line also differs. Therefore, there is a correlation between the voltage of the power supply line and the state of the inrush current suppressing section. Therefore, if the voltage of the power supply line in the case where the switching section is driven to the on-state does not match the driven state of the inrush current suppressing section, the abnormality detecting section can determine that the driven state of inrush current suppressing section differs from an actual state and that an uncontrollable abnormality exists in the inrush current suppressing section.

Therefore, the starter controller having such the abnormality detecting section can detect the occurrence of the uncontrollable abnormality in the inrush current suppressing section.

According to a second example aspect of the present invention, the inrush current suppressing section is selectively driven between the first state where a resistor is inserted into the power supply line in series and the second state where the resistor is not inserted into the power supply line. In the case where the inrush current suppressing section having such the resistor is used, if the switching section is driven to the on-state, the current flows to the starter motor irrespective of the state of the inrush current suppressing section. If the inrush current suppressing section is in the first state, the current flows from the power supply to the starter motor through the resistor. If the inrush current suppressing section is in the second state, the current flows from the power supply to the starter motor without passing through the resistor.

In the case where such the inrush current suppressing section having the resistor is used, according to a third example aspect of the present invention, the abnormality detecting section detects whether a fixation abnormality, in which the inrush current suppressing section cannot switch the state, occurs in the inrush current suppressing section based on an output voltage of the power supply at the time when the switching section is driven to the on-state (i.e., based on output voltage of power supply as of energization to starter motor).

The detection principle is as follows. An energization current IM1 in the case where the inrush current suppressing section is driven to the first state and the starter motor is energized is smaller than an energization current IM2 in the case where the inrush current suppressing section is driven to the second state and the starter motor is energized (i.e., IM1<IM2). It is because the resistor is inserted into the power supply line in the former case, and the energization current to the starter motor decreases correspondingly.

There is impedance inside the power supply (i.e., internal impedance exists). Therefore, the output voltage V1 of the power supply in the case where the inrush current suppressing section is driven to the first state and the starter motor is energized takes a value different from the output voltage V2 of the power supply in the case where the inrush current suppressing section is driven to the second state and the starter motor is energized. In a normal case, the output voltage V1 is higher than the output voltage V2 (V1>V2). Since the current IM1 is smaller than the current IM2, a voltage drop inside the power supply is smaller in the former case than in the latter case.

A normal value, which the output voltage V1 should take normally, may be defined as a value Vs1. A normal value, which the output voltage V2 should take normally, may be defined as a value Vs2. In this case, if the output voltage V1 is lower than a predetermined value between the values Vs1, Vs2, it can be determined that the inrush current suppressing section is not in the first state, which is supposed to be the set state of the inrush current suppressing section, but in the second state in fact. That is, it can be determined that a fixation abnormality, in which the inrush current suppressing section remains in the second state, occurs. If the output voltage V2 does not become lower than the predetermined value between the values Vs1, Vs2, it can be determined that the inrush current suppressing section is not in the second state, which is supposed to be the set state of the inrush current suppressing section, but in the first state in fact. That is, it can be determined that a fixation abnormality, in which the inrush current suppressing section remains in the first state, occurs. The above-described normal value Vs1 is the output voltage of the power supply in the case where the inrush current suppressing section is in the first state and the starter motor is energized. The above-described normal value Vs2 is the output voltage of the power supply in the case where the inrush current suppressing section is in the second state and the starter motor is energized.

According to a fourth example aspect of the present invention, the abnormality detecting section determines whether the output voltage of the power supply becomes lower than a predetermined second state fixation determination value when the inrush current suppressing section is driven to the first state and the switching section is driven to the on-state. The abnormality detecting section determines that a fixation abnormality (referred to also as second state fixation abnormality, hereafter), in which the inrush current suppressing section remains in the second state, occurs in the inrush current suppressing section if the output voltage becomes lower than the second state fixation determination value.

According to a ninth example aspect of the present invention, the abnormality detecting section determines whether the output voltage of the power supply becomes lower than a predetermined first state fixation determination value when the inrush current suppressing section is driven to the second state and the switching section is driven to the on-state. The abnormality detecting section determines that a fixation abnormality (referred to also as first state fixation abnormality, hereafter), in which the inrush current suppressing section remains in the first state, occurs in the inrush current suppressing section if the output voltage does not become lower than the first state fixation determination value.

The second state fixation determination value and the first state fixation determination value can be set at a voltage value or values between the values Vs1, Vs2. The second state fixation determination value and the first state fixation determination value may be the same value or may be different values.

According to a fifth example aspect of the present invention, in the starter controller according to the fourth example aspect of the present invention, the starter has a pinion gear that is rotated by the motor and that cranks the engine when the pinion gear is rotated in a state where the pinion gear is engaged with a ring gear of the engine. The starter is constructed to be able to switch between a state where the pinion gear is engaged with the ring gear and a state where the pinion gear is disengaged from the ring gear regardless of whether the motor is energized or not.

The abnormality detecting section performs second state fixation abnormality detection processing at non-start timing in one or both of the operation of the engine, which is before the idle reduction controlling section stops the engine, and idle reduction, which extends since the idle reduction controlling section stops the engine until the idle reduction controlling section restarts the engine, as the processing for detecting the occurrence of the fixation abnormality, in which the inrush current suppressing section remains in the second state, in the inrush current suppressing section.

In the second state fixation abnormality detection processing at non-start timing, the pinion gear is brought to the state where the pinion gear is disengaged from the ring gear, the inrush current suppressing section is driven to the first state, and the switching section is driven to the on-state. It is determined whether the output voltage of the power supply becomes lower than a first determination value for second state fixation. If the output voltage becomes lower than the first determination value for second state fixation, it is determined that the fixation abnormality, in which the inrush current suppressing section remains in the second state, occurs in the inrush current suppressing section.

That is, in the second state fixation abnormality detection processing at non-start timing, the starter motor is energized while disengaging the pinion gear of the starter from the ring gear of the engine under a situation where the cranking of the engine is unnecessary. Thus, it is determined whether the second state fixation abnormality exists in the inrush current suppressing section without causing the starter to crank the engine.

With such the construction, the occurrence of the second state fixation abnormality in the inrush current suppressing section can be detected before the restart of the engine accompanying the establishment of the automatic start condition. When the starter motor is energized by the restart energization processing with the starter controller according to the fifth example aspect of the present invention, the starter may be caused to crank the engine by engaging the pinion gear with the ring gear.

According to a sixth example aspect of the present invention, in the starter controller according to the fourth or fifth example aspect of the present invention, when the starter controller performs the restart energization processing to drive the inrush current suppressing section to the first state and to drive the switching section to the on-state, the abnormality detecting section performs second state fixation abnormality detection processing at restart as the processing for detecting whether the fixation abnormality, in which the inrush current suppressing section remains in the second state, occurs in the inrush current suppressing section. In the second state fixation abnormality detection processing at restart, it is determined whether the output voltage of the power supply becomes lower than a second determination value for second state fixation. It is determined that the fixation abnormality, in which the inrush current suppressing section remains in the second state, occurs in the inrush current suppressing section if the output voltage becomes lower than the second determination value for second state fixation.

That is, in the second state fixation abnormality detection processing at restart, it is determined whether the second state fixation abnormality has occurred in the inrush current suppressing section by using the restart energization processing performed to restart the engine from the idle reduction state (automatic stop state of engine). This scheme gives an advantage that there is no need to drive the inrush current suppressing section and the switching section only for the abnormality detection.

The second determination value for second state fixation and the first determination value for second state fixation may be the same value or may be different values.

According to a seventh example aspect of the present invention, the starter controller according to any one of the fourth to sixth example aspects of the present invention has a first prohibiting section. The first prohibiting section prohibits the idle reduction controlling section from stopping the engine when the abnormality detecting section determines that the fixation abnormality, in which the inrush current suppressing section remains in the second state, occurs in the inrush current suppressing section.

With such the construction, when the second state fixation abnormality occurs in the inrush current suppressing section, the idle reduction (i.e., automatic stop of engine by idle reduction controlling section) is not performed. Therefore, the engine restart from the idle reduction state is no longer performed. That is, there is no need to perform the engine restart from the idle reduction state. Therefore, the problem that the inrush current to the starter motor cannot be suppressed in the restart of the engine so that the power supply voltage falls and some controller in the vehicle is reset can be avoided.

According to an eighth example aspect of the present invention, the starter controller according to any one of the fourth to seventh example aspects of the present invention has a first informing section. The first informing section informs a vehicle driver of the occurrence of the fixation abnormality, in which the inrush current suppressing section remains in the second state, in the inrush current suppressing section when the abnormality detecting section determines that the fixation abnormality, in which the inrush current suppressing section remains in the second state, occurs in the inrush current suppressing section. Therefore, the occurrence of the abnormality can be informed to the driver, and early repair can be urged.

According to a tenth example aspect of the present invention, in the starter controller according to the ninth example aspect of the present invention, the starter is constructed to be able to switch between a state where the pinion gear is engaged with the ring gear and a state where the pinion gear is disengaged from the ring gear regardless of whether the motor is energized or not.

The abnormality detecting section performs first state fixation abnormality detection processing at non-start timing in one or both of the operation of the engine, which is before the idle reduction controlling section stops the engine, and the idle reduction, which extends since the idle reduction controlling section stops the engine until the idle reduction controlling section restarts the engine, as the processing for detecting whether the fixation abnormality, in which the inrush current suppressing section remains in the first state, occurs in the inrush current suppressing section.

In the first state fixation abnormality detection processing at non-start timing, the pinion gear is disengaged from the ring gear, the inrush current suppressing section is driven to the second state, and the switching section is driven to the on-state. It is determined whether the output voltage of the power supply becomes lower than a first determination value for first state fixation. If the output voltage does not become lower than the first determination value for first state fixation, it is determined that the fixation abnormality, in which the inrush current suppressing section remains in the first state, occurs in the inrush current suppressing section.

That is, in the first state fixation abnormality detection processing at non-start timing, the starter motor is energized while disengaging the pinion gear of the starter from the ring gear of the engine under a situation where the cranking of the engine is unnecessary. Thus, it is determined whether the first state fixation abnormality has occurred in the inrush current suppressing section without causing the starter to crank the engine.

With such the construction, the occurrence of the first state fixation abnormality in the inrush current suppressing section can be detected before the restart of the engine accompanying the establishment of the automatic start condition. Also in the case of the tenth example aspect, like the fifth example aspect, when the starter motor is energized by the restart energization processing, the engine may be cranked with the starter by engaging the pinion gear with the ring gear.

According to an eleventh example aspect of the present invention, the starter controller according to the ninth or tenth example aspect of the present invention performs initial start energization processing for driving the inrush current suppressing section to the second state and for driving the switching section to the on-state as energization processing for energizing the starter motor such that the starter cranks the engine when the starter controller starts the engine in response to a starting operation by the vehicle driver. By such the processing, the current flows to the starter motor without passing through the resistor from the beginning of the energization.

When the starter controller performs the initial start energization processing, the abnormality detecting section performs first state fixation abnormality detection processing at initial start as processing for detecting whether the fixation abnormality, in which the inrush current suppressing section remains in the first state, occurs in the inrush current suppressing section. In the first state fixation abnormality detection processing at initial start, it is determined whether the output voltage of the power supply becomes lower than a second determination value for first state fixation. If the output voltage does not become lower than the second determination value for first state fixation, it is determined that the fixation abnormality, in which the inrush current suppressing section remains in the first state, occurs in the inrush current suppressing section.

That is, in the first state fixation abnormality detection processing at initial start, it is determined whether the first state fixation abnormality exists in the inrush current suppressing section by using the initial start energization processing performed to start the engine in response to a starting operation by the vehicle driver (for example, operation to twist key or to push start switch). This scheme gives an advantage that there is no need to drive the inrush current suppressing section and the switching section only for the abnormality detection.

The initial start energization processing is for energizing the starter motor while driving the inrush current suppressing section to the second state (i.e., state where resistor is not put in power supply line to motor) from the beginning. Such the initial start energization processing is performed when the engine is started in response to the starting operation by the vehicle driver for the above-mentioned reason.

The second determination value for first state fixation may be the same value as or a value different from the first determination value for first state fixation. In the case of the starter controller according to the eleventh example aspect assuming the tenth example aspect, the engine may be cranked with the starter by engaging the pinion gear with the ring gear also in the case where the starter motor is energized by the initial start energization processing.

According to a twelfth example aspect of the present invention, in the starter controller according to the eleventh example aspect of the present invention, if the abnormality detecting section determines that the fixation abnormality, in which the inrush current suppressing section remains in the first state, occurs in the inrush current suppressing section when the starter controller performs the initial start energization processing (i.e., if first state fixation abnormality is detected by first state fixation abnormality detection processing at initial start), the abnormality detecting section restricts an energization time of the energization to the motor in present initial start energization processing to a predetermined time.

With such the construction, burning out of the resistor of the inrush current suppressing section due to the energization to the starter motor can be prevented. Specifically, if the motor is energized for a long time when the first state fixation abnormality exists in the inrush current suppressing section, there is a possibility that the resistor of the inrush current suppressing section burns out. If the resistor burns out, the energization to the starter motor cannot be performed thereafter. Such the situation can be prevented by the above construction.

According to a thirteenth example aspect of the present invention, the starter controller according to any one of the ninth to twelfth example aspects of the present invention further has a second prohibiting section. When the abnormality detecting section determines that the fixation abnormality, in which the inrush current suppressing section remains in the first state, occurs in the inrush current suppressing section, the second prohibiting section prohibits the idle reduction controlling section from stopping the engine.

With such the construction, when the first state fixation abnormality occurs in the inrush current suppressing section, the idle reduction (i.e., automatic stop of engine by idle reduction controlling section) is not performed. Therefore, the restart of the engine from the idle reduction state is not performed, either. Therefore, the problem of the burning out of the resistor of the inrush current suppressing section in the engine restart can be avoided.

According to a fourteenth example aspect of the present invention, the starter controller according to any one of the ninth to thirteenth example aspects of the present invention further has a second informing section. The second informing section informs the vehicle driver of the occurrence of the fixation abnormality, in which the inrush current suppressing section remains in the first state, in the inrush current suppressing section when the abnormality detecting section determines that the fixation abnormality, in which the inrush current suppressing section remains in the first state, occurs in the inrush current suppressing section. Therefore, the occurrence of the abnormality can be informed to the driver, and early repair can be urged.

According to a fifteenth example aspect of the present invention, the starter controller is the same as the starter controller according to the sixth example aspect assuming the starter controller according to the fifth example aspect. The second determination value for second state fixation is set at a smaller value than the first determination value for second state fixation.

The engine is cranked when the second state fixation abnormality detection processing at restart is performed. The engine is not cranked when the second state fixation abnormality detection processing at non-start timing is performed. Therefore, the current flowing through the starter motor in the former case is larger than the current flowing through the starter motor in the latter case by an increase amount of a rotation load of the motor. Therefore, the output voltage of the power supply in the former case tends to decrease as compared to the latter case. Therefore, the second determination value for second state fixation used in the former case is set at a value smaller than the first determination value for second state fixation used in the latter case. Thus, abnormality determination accuracy in the both cases, i.e., abnormality determination accuracy of the second state fixation abnormality detection processing at restart and abnormality determination accuracy of the second state fixation abnormality detection at non-start timing, can be improved.

According to a sixteenth example aspect of the present invention, the starter controller is the same as the starter controller according to the eleventh example aspect assuming the starter controller according to the tenth example aspect. The second determination value for first state fixation is set at a smaller value than the first determination value for first state fixation.

Therefore, abnormality determination accuracy of the first state fixation abnormality detection processing at initial start and the first state fixation abnormality detection at non-start timing can be improved. The reason is the same as the reason described in the above description of the starter controller according to the fifteenth example aspect.

In the starter controller according to the fifth example aspect or the starter controller assuming the same, the abnormality detecting section should preferably perform the second state fixation abnormality detection processing at non-start timing when running speed of the vehicle is higher than zero. Likewise, in the starter controller according to the tenth example aspect or the starter controller assuming the same, the abnormality detecting section should preferably perform the first state fixation abnormality detection processing at non-start timing when the running speed of the vehicle is higher than zero.

It is because the starter motor is energized under the situation where there is essentially no need to energize the starter motor in the second state fixation abnormality detection processing at non-start timing and in the first state fixation abnormality detection processing at non-start timing. It is desirable that an operation sound of the starter motor is not audible to the vehicle occupant. If the vehicle speed is not zero, it is thought that the operation sound of the motor is less audible to the vehicle occupant due to a running sound of the vehicle.

According to a nineteenth example aspect of the present invention, the inrush current suppressing section is a switching element provided in the power supply line. If drive of switching control for switching the switching element alternately between an on-state and an off-state is performed, the switching element is brought to the first state. If drive for continuing the on-state is performed, the switching element is brought to the second state. In this case, a suppressing degree of the current flowing to the starter motor can be changed by changing a duty ratio at the time when the switching control of the switching element is performed. The duty ratio is a ratio of the on-state time to one cycle time, which is the sum of the on-state time and the off-state time.

In the case where the switching element is used as the inrush current suppressing section, according to a twentieth example aspect of the present invention, the abnormality detecting section detects whether an uncontrollable abnormality occurs in the inrush current suppressing section based on the output voltage of the power supply at the time when the switching section is driven to the on-state. If the switching section is in the on-state, the current flowing from the power supply to the starter motor changes according to the state of the switching element as the inrush current suppressing section. If the current changes, the output voltage of the power supply also changes due to the voltage drop inside the power supply. More specifically, the output voltage of the power supply decreases as the current increases. Therefore, the actual state of the switching element can be grasped from the output voltage of the power supply.

More specifically, according to a twenty first example aspect of the present invention, the abnormality detecting section determines whether the output voltage of the power supply becomes lower than a predetermined on-state fixation determination value when the inrush current suppressing section is driven to the first state or the off-state and the switching section is driven to the on-state. If the output voltage becomes lower than the on-state fixation determination value, the abnormality detecting section determines that the fixation abnormality (referred to also as on-state fixation abnormality), in which the inrush current suppressing section remains in the on-state, occurs in the inrush current suppressing section.

According to a twenty sixth example aspect of the present invention, the abnormality detecting section determines whether the output voltage of the power supply becomes lower than a predetermined off-state fixation determination value when the inrush current suppressing section is driven to the second state (i.e., on-state) and the switching section is driven to the on-state. If the output voltage does not become lower than the off-state fixation determination value, the abnormality detecting section determines that a fixation abnormality, in which the inrush current suppressing section remains in the off-state (referred to also as off-state fixation abnormality), occurs in the inrush current suppressing section.

According to a twenty second example aspect of the present invention, in the starter controller according to the twenty first example aspect, the starter has a pinion gear that is rotated by the motor and that cranks the engine when the pinion gear is rotated in a state where the pinion gear is engaged with a ring gear of the engine. The starter is constructed to be able to switch between a state where the pinion gear is engaged with the ring gear and a state where the pinion gear is disengaged from the ring gear regardless of whether the motor is energized or not.

The abnormality detecting section performs on-state fixation abnormality detection processing at non-start timing in one or both of the operation of the engine, which is before the idle reduction controlling section stops the engine, and the idle reduction, which extends since the idle reduction controlling section stops the engine until the idle reduction controlling section restarts the engine, as the processing for detecting whether the fixation abnormality, in which the inrush current suppressing section remains in the on-state, occurs in the inrush current suppressing section.

In the on-state fixation abnormality detection processing at non-start timing, the pinion gear is disengaged from the ring gear, the inrush current suppressing section is driven to the first state or the off-state, and the switching section is driven to the on-state. In such the state, it is determined whether the output voltage of the power supply becomes lower than a first determination value for on-state fixation. If the output voltage becomes lower than the first determination value for on-state fixation, it is determined that the fixation abnormality, in which the inrush current suppressing section remains in the on-state, occurs in the inrush current suppressing section.

That is, in the on-state fixation abnormality detection processing at non-start timing, the pinion gear of the starter is disengaged from the ring gear of the engine under a situation where the cranking of the engine is unnecessary. Thus, it is determined whether the on-state fixation abnormality has occurred in the inrush current suppressing section without causing the starter to crank the engine.

With such the construction, the occurrence of the on-state fixation abnormality in the inrush current suppressing section can be detected before the restart of the engine accompanying the establishment of the automatic start condition. In the starter controller according to the twenty second example aspect, the engine may be cranked with the starter by engaging the pinion gear with the ring gear when the starter motor is energized by the restart energization processing.

According to a twenty third example aspect of the present invention, in the starter controller according to the twenty first or twenty second example aspect, the abnormality detecting section performs on-state fixation abnormality detection processing at restart as the processing for detecting whether the fixation abnormality, in which the inrush current suppressing section remains in the on-state, occurs in the inrush current suppressing section when the starter controller performs the restart energization processing to drive the inrush current suppressing section to the first state and to drive the switching section to the on-state. In the on-state fixation abnormality detection processing at restart, it is determined whether the output voltage of the power supply becomes lower than a second determination value for on-state fixation. If the output voltage of the power supply becomes lower than the second determination value for on-state fixation, it is determined that the fixation abnormality, in which the inrush current suppressing section remains in the on-state, occurs in the inrush current suppressing section.

That is, in the on-state fixation abnormality detection processing at restart, it is determined whether the on-state fixation abnormality occurs in the inrush current suppressing section by using the restart energization processing, which is performed to restart the engine from the idle reduction state (automatic stop state of engine). This scheme gives an advantage that there is no need to drive the inrush current suppressing section and the switching section only for the abnormality detection.

The second determination value for on-state fixation may be the same value as or a value different from the first determination value for on-state fixation.

According to a twenty fourth example aspect of the present invention, the starter controller according to any one of the twenty first to twenty third example aspects further has a first prohibiting section. The first prohibiting section prohibits the idle reduction controlling section from stopping the engine when the abnormality detecting section determines that the fixation abnormality, in which the inrush current suppressing section remains in the on-state, occurs in the inrush current suppressing section.

With such the construction, when the on-state fixation abnormality occurs in the inrush current suppressing section, the idle reduction (automatic stop of engine by idle reduction controlling section) is not performed. The engine restart from the idle reduction state is also not performed (i.e., is unnecessary). Therefore, the above-mentioned problem that the inrush current to the starter motor cannot be suppressed in the restart of the engine so that the power supply voltage falls and some controller in the vehicle is reset can be avoided.

According to a twenty fifth example aspect of the present invention, the starter controller according to any one of the twenty first to twenty fourth example aspects further has a first informing section. The first informing section informs the vehicle driver of the occurrence of the fixation abnormality, in which the inrush current suppressing section remains in the on-state, when the abnormality detecting section determines that the fixation abnormality, in which the inrush current suppressing section remains in the on-state, occurs in the inrush current suppressing section. Accordingly, the occurrence of the abnormality can be informed to the driver, and early repair can be urged.

According to a twenty seventh example aspect of the present invention, in the starter controller according to the twenty sixth example aspect, the starter is constructed to be able to switch between a state where the pinion gear is engaged with the ring gear of the engine and a state where the pinion gear is disengaged from the ring gear regardless of whether the motor is energized or not.

The abnormality detecting section performs off-state fixation abnormality detection processing at non-start timing in one or both of the operation of the engine, which is before the idle reduction controlling section stops the engine, and the idle reduction, which extends since the idle reduction controlling section stops the engine until the idle reduction controlling section restarts the engine, as the processing for detecting whether the fixation abnormality, in which the inrush current suppressing section remains in the off-state, occurs in the inrush current suppressing section.

In the off-state fixation abnormality detection processing at non-start timing, the pinion gear is disengaged from the ring gear, the inrush current suppressing section is driven to the second state (i.e., on-state), and the switching section is driven to the on-state. In such the state, it is determined whether the output voltage of the power supply becomes lower than the off-state fixation determination value. If the output voltage of the power supply does not become lower than the off-state fixation determination value, it is determined that the fixation abnormality, in which the inrush current suppressing section remains in the off-state, occurs in the inrush current suppressing section.

That is, in the off-state fixation abnormality detection processing at non-start timing, the starter motor is energized while disengaging the pinion gear of the starter from the ring gear of the engine under a situation where the cranking of the engine is unnecessary. Thus, it is determined whether the off-state fixation abnormality exists in the inrush current suppressing section without causing the starter to crank the engine.

With such the construction, the occurrence of the off-state fixation abnormality in the inrush current suppressing section can be detected before the restart of the engine accompanying the establishment of the automatic start condition. Also in the case of the starter controller according to the twenty seventh example aspect, the engine may be cranked with the starter by engaging the pinion gear with the ring gear when the starter motor is energized by the restart energization processing.

According to a twenty eighth example aspect of the present invention, the starter controller according to the twenty sixth or twenty seventh example aspect performs initial start energization processing for driving the inrush current suppressing section to the second state and for driving the switching section to the on-state as energization processing for energizing the starter motor in order to crank the engine with the starter when starting the engine in response to a starting operation by the vehicle driver. With such the processing, the current flows to the starter motor from the beginning of the energization without being suppressed by the inrush current suppressing section.

The abnormality detecting section performs off-state fixation abnormality detection processing at initial start as the processing for detecting whether the fixation abnormality, in which the inrush current suppressing section remains in the off-state, occurs in the inrush current suppressing section when the starter controller performs the initial start energization processing. In the off-state fixation abnormality detection processing at initial start, it is determined whether the output voltage of the power supply becomes lower than the off-state fixation determination value. If the output voltage of the power supply does not become lower than the off-state fixation determination value, it is determined that the fixation abnormality, in which the inrush current suppressing section remains in the off-state, occurs in the inrush current suppressing section.

That is, in the off-state fixation abnormality detection processing at initial start, it is determined whether the off-state fixation abnormality exists in the inrush current suppressing section by using the initial start energization processing, which is performed to start the engine in response to the starting operation by the driver (e.g., twisting operation of key or pushing operation of start switch). This scheme gives an advantage that there is no need to drive the inrush current suppressing section and the switching section only for the abnormality detection.

In the case of the starter controller according to the twenty eighth example aspect assuming the starter controller according to the twenty seventh example aspect, the engine may be cranked with the starter by engaging the pinion gear with the ring gear also when the starter motor is energized by the initial start energization processing.

According to a twenty ninth example aspect of the present invention, the starter controller according to any one of the twenty sixth to twenty eighth example aspects further has a second prohibiting section. The second prohibiting section prohibits the idle reduction controlling section from stopping the engine when the abnormality detecting section determines that the fixation abnormality, in which the inrush current suppressing section remains in the off-state, occurs in the inrush current suppressing section.

With such the construction, when the off-state fixation abnormality occurs in the inrush current suppressing section, the idle reduction (automatic stop of engine by idle reduction controlling section) is not performed. Therefore, the situation where the engine cannot be restarted can be avoided. It is because the starter motor cannot be energized if the off-state fixation abnormality occurs in the inrush current suppressing section.

According to a thirtieth example aspect of the present invention, the starter controller according to any one of the twenty sixth to twenty ninth example aspects further has a second informing section. The second informing section informs the vehicle driver of the occurrence of the fixation abnormality, in which the inrush current suppressing section remains in the off-state, when the abnormality detecting section determines that the fixation abnormality, in which the inrush current suppressing section remains in the off-state, occurs in the inrush current suppressing section. Therefore, the occurrence of the abnormality can be informed to the driver, and early repair can be urged.

According to a thirty first example aspect of the present invention, the starter controller is the same as the starter controller according to the twenty third example aspect assuming the starter controller according to the twenty second aspect. The second determination value for on-state fixation is set at a smaller value than the first determination value for on-state fixation.

The engine is cranked when the on-state fixation abnormality detection processing at restart is performed. The engine is not cranked when the on-state fixation abnormality detection processing at non-start timing is performed. The current flowing through the starter motor in the former case is larger than the current flowing through the starter motor in the latter case by the increase amount of the rotation load of the motor. Therefore, the output voltage of the power supply tends to decrease in the former case as compared to the latter case. Therefore, the second determination value for on-state fixation used in the former case is set at the smaller value than the first determination value for on-state fixation used in the latter case. Thus, abnormality determination accuracy in the both cases, i.e., abnormality determination accuracy of the on-state fixation abnormality detection processing at restart and abnormality determination accuracy of the on-state fixation abnormality detection at non-start timing, can be improved.

According to a thirty second example aspect of the present invention, in the starter controller according to the twenty second example aspect or the starter controller assuming the same, the abnormality detecting section performs the on-state fixation abnormality detection processing at non-start timing when running speed of the vehicle is higher than zero.

The on-state fixation abnormality detection processing at non-start timing is performed in the situation where there is essentially no need to energize the starter motor. It is desirable that the operation sound of the starter motor accompanying the energization to the starter motor is not audible to the vehicle occupant. If the vehicle speed is not zero, it is thought that the operation sound of the motor is less audible to the vehicle occupant due to the running sound of the vehicle. Therefore, the above construction is preferable.

If the inrush current suppressing section is driven to the off-state in the on-state fixation abnormality detection processing at non-start timing, the starter motor is not energized when the inrush current suppressing section is normal. However, if the on-state fixation abnormality exists in the inrush current suppressing section, the starter motor is energized and operated. Also in this case, it is desirable that the operation sound of the starter motor is not audible to the vehicle occupant.

According to a thirty third example aspect of the present invention, in the starter controller according to the twenty seventh example aspect or the starter motor assuming the same, the abnormality detecting section performs the off-state fixation abnormality detection processing at non-start timing when running speed of the vehicle is higher than zero.

If the inrush current suppressing section is normal, the starter motor is energized under the situation where there is essentially no need to energize the starter motor in the off-state fixation abnormality detection processing at non-start timing. Therefore, it is desirable that the operation sound of the starter motor is not audible to the vehicle occupant. If the vehicle speed is not zero, it is thought that the operation sound of the motor is less audible to the vehicle occupant due to the running sound of the vehicle.

According to a thirty fourth example aspect of the present invention, in the starter controller according to the twentieth example aspect, the abnormality detecting section monitors the output voltage of the power supply when the starter controller performs the restart energization processing to drive the inrush current suppressing section to the first state and to drive the switching section to the on-state. The abnormality detecting section determines that the fixation abnormality, in which the inrush current suppressing section remains in the on-state, occurs in the inrush current suppressing section if the output voltage of the power supply becomes lower than a predetermined on-state fixation determination value. The abnormality detecting section determines that the fixation abnormality, in which the inrush current suppressing section remains in the off-state, occurs in the inrush current suppressing section if the output voltage of the power supply does not become lower than an off-state fixation determination value, which is higher than the on-state fixation determination value.

With such the construction, the on-state fixation abnormality and the off-state fixation abnormality of the inrush current suppressing section can be detected distinctly by using the restart energization processing performed in the restart of the engine from the idle reduction state. Therefore, there is no need to provide the inrush current suppressing section and the switching section only for the abnormality detection.

According to a thirty fifth example aspect of the present invention, in the starter controller according to the twentieth example aspect, the starter is constructed to be able to switch between a state where the pinion gear is engaged with the ring gear of the engine and a state where the pinion gear is disengaged from the ring gear regardless of whether the motor is energized or not.

The abnormality detecting section disengages the pinion gear from the ring gear, drives the inrush current suppressing section to the first state, drives the switching section to the on-state, and monitors the output voltage of the power supply at that time during one or both of the operation of the engine, which is before the idle reduction controlling section stops the engine, and the idle reduction, which extends since the idle reduction controlling section stops the engine until the idle reduction controlling section restarts the engine. The abnormality detecting section determines that the fixation abnormality, in which the inrush current suppressing section remains in the on-state, occurs in the inrush current suppressing section if the monitored output voltage becomes lower than a predetermined on-state fixation determination value. The abnormality detecting section determines that the fixation abnormality, in which the inrush current suppressing section remains in the off-state, occurs in the inrush current suppressing section if the monitored output voltage does not become lower than an off-state fixation determination value higher than the on-state fixation determination value.

With such the construction, the on-state fixation abnormality and the off-state fixation abnormality of the inrush current suppressing section can be detected distinctly before the restart of the engine accompanying the establishment of the automatic start condition. In this starter controller, the abnormality detecting section may be constructed to operate when the running speed of the vehicle is higher than zero. Such the construction is desirable because the operation sound of the motor due to the energization for the abnormality detection is less audible to the occupant due to the running sound of the vehicle.

According to a thirty sixth example aspect of the present invention, in the starter controller according to the third example aspect, the abnormality detecting section senses change speed of the output voltage at the time when the starter controller performs the restart energization processing to drive the inrush current suppressing section to the first state and to drive the switching section to the on-state. The abnormality detecting section determines that the fixation abnormality, in which the inrush current suppressing section remains in the second state, occurs in the inrush current suppressing section if the change speed is equal to or higher than a predetermined value.

With such the construction, the occurrence of the second state fixation abnormality in the inrush current suppressing section can be detected at the restart of the engine from the idle reduction state without driving the inrush current suppressing section and the switching section only for the abnormality detection.

According to a thirty seventh example aspect of the present invention, the starter controller according to the third example aspect performs initial start energization processing for driving the inrush current suppressing section to the second state and for driving the switching section to the on-state as energization processing for energizing the starter motor such that the starter cranks the engine when the starter controller starts the engine in response to a starting operation by a vehicle driver.

The abnormality detecting section senses change speed of the output voltage at the time when the starter controller performs the initial start energization processing to drive the inrush current suppressing section to the second state and to drive the switching section to the on-state. The abnormality detecting section determines that the fixation abnormality, in which the inrush current suppressing section remains in the first state, occurs in the inrush current suppressing section when the change speed is lower than a predetermined value.

With such the construction, the occurrence of the first state fixation abnormality in the inrush current suppressing section can be detected in the start of the engine (initial start) corresponding to the starting manipulation by the driver without driving the inrush current suppressing section and the switching section only for the abnormality detection.

### BRIEF DESCRIPTION OF THE DRAWINGS

Features and advantages of embodiments will be appreciated, as well as methods of operation and the function of the related parts, from a study of the following detailed description, the appended claims, and the drawings, all of which form a part of this application. In the drawings:

FIG. 1 is a schematic diagram showing an ECU and peripheral devices according to a first embodiment of the present invention;

FIG. 2 is an explanatory diagram showing engine states in time series according to the first embodiment;

FIGS. 3A and 3B are explanatory diagrams showing a detection principle of a fixation abnormality in an ICR relay according to the first embodiment;

FIG. 4 is another explanatory diagram showing the detection principle of the fixation abnormality in the ICR relay according to the first embodiment;

FIG. 5 is a further explanatory diagram showing the detection principle of the fixation abnormality in the ICR relay according to the first embodiment;

FIG. 6 is a flowchart showing diagnostic processing at initial start according to the first embodiment;

FIG. 7 is a flowchart showing normal start control processing for initial engine start according to the first embodiment;

FIG. 8 is a flowchart showing diagnostic processing during engine operation and diagnostic processing during idle reduction according to the first embodiment;

FIG. 9 is a flowchart showing diagnostic processing at restart according to the first embodiment;

FIG. 10 is a flowchart showing normal start control processing for engine restart according to the first embodiment;

FIG. 11 is a schematic diagram showing an ECU and peripheral devices according to a second embodiment of the present invention;

FIG. 12 is a schematic diagram showing an ECU and peripheral devices according to a third embodiment of the present invention;

FIG. 13 is a schematic diagram showing an ECU and peripheral devices according to a fourth embodiment of the present invention;

FIG. 14 is a schematic diagram showing an ECU and peripheral devices according to a fifth embodiment of the present invention;

FIG. 15 is a first explanatory diagram showing a detection principle of an abnormality in a transistor group according to the fifth embodiment;

FIG. 16 is a second explanatory diagram showing a detection principle of the abnormality in the transistor group according to the fifth embodiment;

FIG. 17 is a flowchart showing diagnostic processing at initial start according to the fifth embodiment;

FIG. 18 is a flowchart showing diagnostic processing during engine operation and diagnostic processing during idle reduction according to the fifth embodiment;

FIG. 19 is a flowchart showing diagnostic processing at restart according to the fifth embodiment;

FIG. 20 is a flowchart showing diagnostic processing during engine operation and diagnostic processing during idle reduction according to a sixth embodiment of the present invention; and

FIG. 21 is an explanatory diagram showing control of a suppression amount of an inrush current according to a modification of the present invention.

### DETAILED DESCRIPTION OF EXAMPLE EMBODIMENTS

Hereafter, an electronic control unit (ECU) as a starter controller according to each of embodiments of the present invention will be explained.

### First Embodiment

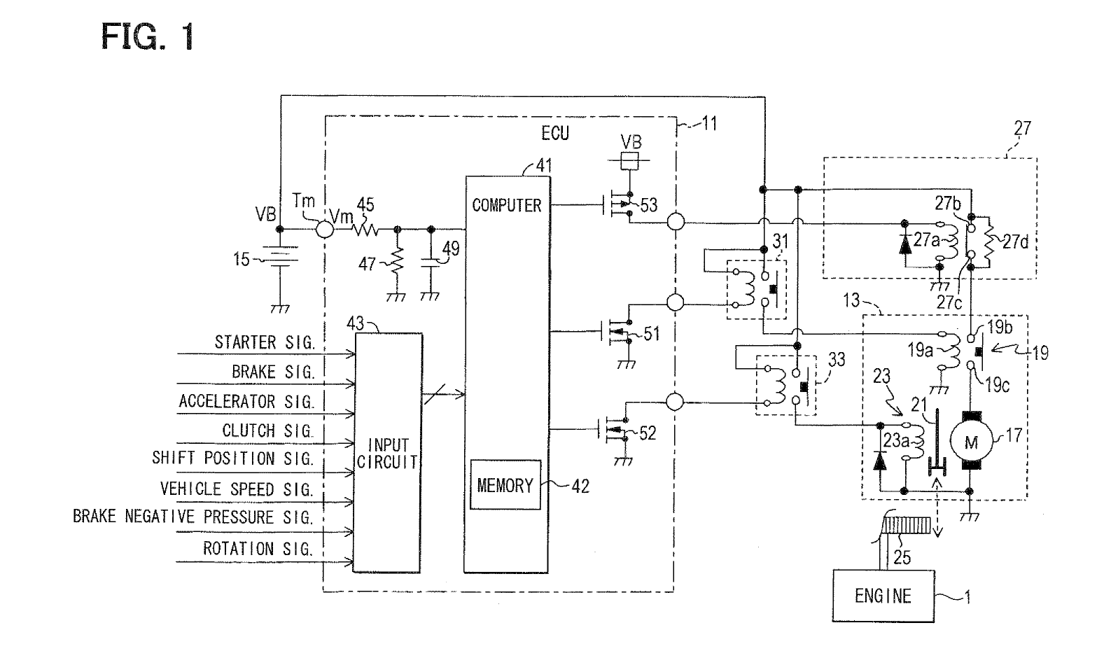

FIG. 1 is a schematic construction diagram showing an ECU 11 according to a first embodiment of the present invention and peripheral devices of the ECU 11. The ECU 11 performs control of a starter 13 for starting an engine 1 of a vehicle (not shown). The ECU 11 also performs idle reduction control for automatically stopping and automatically starting the engine 1. Following explanation will be given on an assumption that a transmission of the vehicle is a manual transmission.

The ECU 11 receives inputs of a starter signal, which becomes an active level when a vehicle driver performs a starting operation (e.g., manipulation to twist key put in key cylinder to start position or manipulation to push start button), a brake signal from a sensor for detecting whether a brake pedal is stepped on, an accelerator signal from a sensor for detecting whether an accelerator pedal is stepped on, a clutch signal from a sensor for detecting whether a clutch pedal is stepped on, a shift position signal from a sensor for sensing a manipulation position of a shift lever (i.e., shift position), a vehicle speed signal from a sensor for sensing running speed of the vehicle (i.e., vehicle speed), a brake negative pressure signal from a sensor for sensing brake negative pressure (negative pressure of brake power assist), rotation signals from a crankshaft sensor and a camshaft sensor, and the like. A battery voltage VB as an output voltage of an in-vehicle battery 15 (corresponding to power supply) is inputted to a voltage monitor terminal Tm of the ECU 11. When the battery voltage VB is supplied to an ignition system power supply line in the vehicle (i.e., when ignition is on), the ECU 11 operates with an electric power from the ignition system power supply line.

The starter 13 has a motor 17 (starter motor) as a power source for cranking the engine 1, an electromagnetic switch 19 for energizing the motor 17, a pinion gear 21 rotated by the motor, and a pinion actuation solenoid 23.

The electromagnetic switch 19 is a large-size relay provided in a power supply line from the battery 15 to the motor 17. The electromagnetic switch 19 is selectively driven between an on-state where the electromagnetic switch 19 connects the power supply line and an off-state where the electromagnetic switch 19 disconnects the power supply line. The electromagnetic switch 19 has a coil 19a, an end of which is connected to a ground line, and a pair of contacts 19b, 19c. If the battery voltage VB is applied to the other end of the coil 19a and the coil 19a is energized, the contacts 19b, 19c short-circuit and connect the power supply line (i.e., on-state is formed). If the coil 19a is deenergized, the contacts 19b, 19c open to disconnect the power supply line (i.e., off-state is formed).

The pinion actuation solenoid 23 is for switching the pinion gear 21 between a state where the pinion gear 21 is engaged with a ring gear 25 of the engine 1 and a state where the pinion gear 21 is disengaged from the ring gear 25.

The pinion actuation solenoid 23 has a coil 23a, an end of which is connected to the ground line, and a biasing member such as a spring (not shown). When the coil 23a is deenergized, the pinion actuation solenoid 23 positions the pinion gear 21 in an initial position (position shown in FIG. 1), where the pinion gear 21 is disengaged from the ring gear 25, by using the force of the biasing member. If the battery voltage VB is applied to the other end of the coil 23a and the coil 23a is energized, the pinion actuation solenoid 23 causes the pinion gear 21 to protrude to an outside of the starter 13 as shown by a dotted arrow mark in FIG. 1 by using an electromagnetic force caused by the energization. Thus, the pinion gear 21 is engaged with the ring gear 25.

If the motor 17 is energized in the state where the pinion gear 21 is engaged with the ring gear 25, a rotational force of the motor 17 is transmitted to the ring gear 25 through the pinion gear 21. Thus, the engine 1 is cranked.

An inrush current reduction relay 27 (ICR relay) for suppressing an inrush current to the motor 17 is provided in the power supply line from the battery 15 to the contacts 19b, 19c of the electromagnetic switch 19 in the vehicle.

The ICR relay 27 has a coil 27a, an end of which is connected to the ground line, a pair of contacts 27b, 27c connected in series with the power supply line to the motor 17, and a resistor 27d (current suppression resistor) connected in parallel to the contacts 27b, 27c for current suppression. If the battery voltage VB is applied to the other end of the coil 27a and the coil 27a is energized, the contacts 27b, 27c open to form a first state, in which the resistor 27d is inserted into the power supply line to the motor 17 in series. If the coil 27a is deenergized, the contacts 27b, 27c short-circuit and form a second state, in which the power supply line is connected without inserting the resistor 27d into the power supply line. In the following description, the first state of the ICR relay 27 will be referred to as “a resistor side,” and the second state of the ICR relay 27 will be referred to as “a contact side.”

Therefore, if the ICR relay 27 is brought to the resistor side and the electromagnetic switch 19 is brought to the on-state (i.e., contacts 19b, 19c are short-circuited), the current flows from the battery 15 to the motor 17 through the resistor 27d. If the ICR relay 27 is brought to the contact side and the electromagnetic switch 19 is brought to the on-state, the current flows from the battery 15 to the motor 17 without passing through the resistor 27d. That is, the current passed to the motor 17 is suppressed more in the first state, in which the current flows through the resistor 27d, than in the second state. The current passed to the motor 17 is not suppressed in the second state because the current flows without passing through the resistor 27d.

In the vehicle, a relay 31 for motor drive and a relay 33 for pinion drive are provided outside the ECU 11. When the motor drive relay 31 is switched on, the motor drive relay 31 applies the battery voltage VB to the other end of the coil 19a of the electromagnetic switch 19 to pass the current to the coil 19a and to bring the electromagnetic switch 19 to the on-state. When the pinion drive relay 33 is switched on, the pinion drive relay 33 applies the battery voltage VB to the other end of the coil 23a of the pinion actuation solenoid 23 to pass the current to the coil 23a and to engage the pinion gear 21 with the ring gear 25 of the engine 1.

The ECU 11 has a microcomputer 41, an input circuit 43, two resistors 45, 47 and a capacitor 49. The microcomputer 41 executes various types of processing for idle reduction control and control of the starter 13. The input circuit 43 inputs the various signals such as the starter signal to the microcomputer 41. The two resistors 45, 47 divide the battery voltage VB, which is inputted from the voltage monitor terminal Tm, into a voltage value that can be inputted to the microcomputer 41. Hereafter, the battery voltage VB inputted from the voltage monitor terminal Tm will be referred to also as a monitor voltage Vm. The capacitor 49 is provided between a voltage line at a connection between the two resistors 45, 47 and the ground line in order to remove a noise. The microcomputer 41 senses the battery voltage VB by performing ND conversion of the voltage at the connection between the two resistors 45, 47 with an internal A/D converter (not shown). The microcomputer 41 senses a voltage value of an analog signal among the signals inputted from the input circuit 43 by performing the A/D conversion of the analog signal with the internal A/D converter.

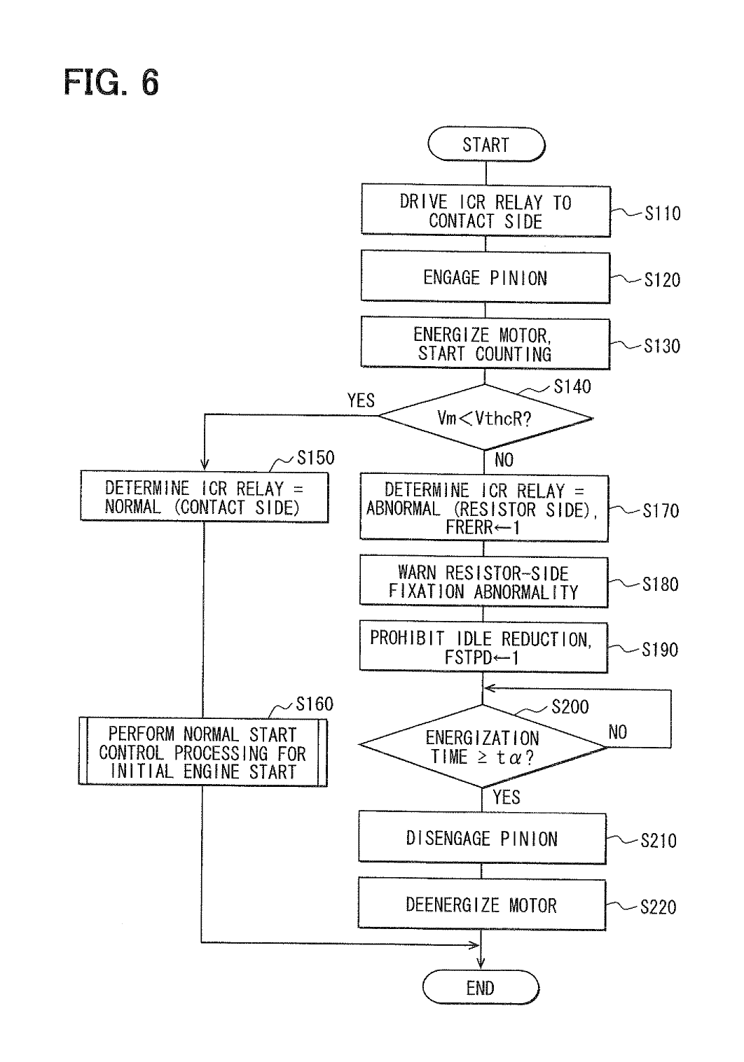

The microcomputer 41 has a memory 42. The microcomputer 41 reads out programs of processing shown in FIGS. 6 to 10 (explained later) from the memory 42 and rewrites error flags in the memory 42.

The ECU 11 has transistors 51, 52, 53. When the transistor 51 is switched on, the transistor 51 passes the current to the coil of the motor drive relay 31 to switch on the relay 31. When the transistor 52 is switched on, the transistor 52 passes the current to the coil of the pinion drive relay 33 to switch on the relay 33. When the transistor 53 is switched on, the transistor 53 passes the current to the coil 27a of the ICR relay 27 to switch the ICR relay 27 to the resistor side. The transistors 51-53 are driven by the microcomputer 41.

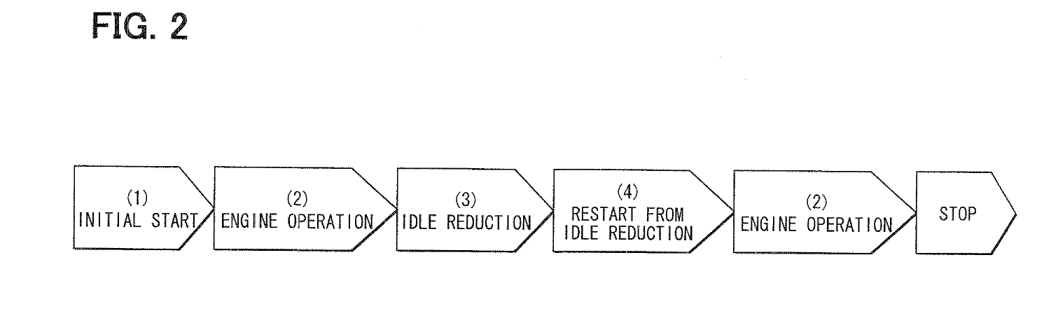

Next, contents of the processing performed by the microcomputer 41 will be explained with reference to FIG. 2. FIG. 2 shows states of the engine 1 in time series. First, when the vehicle driver performs the starting operation and the starter signal switches to the active level (e.g., high level), the microcomputer 41 causes the starter 13 to crank the engine 1 to start the engine 1. This is the state (1) of an initial start in FIG. 2.

In concrete processing, the microcomputer 41 switches on the transistor 52 to switch on the relay 33, thereby passing the current to the coil 23a of the pinion actuation solenoid 23 and engaging the pinion gear 21 with the ring gear 25. The microcomputer 41 keeps the transistor 53 at the off-state to maintain the ICR relay 27 to the contact side. In addition, the microcomputer 41 switches on the transistor 51 to switch on the relay 31 and to bring the electromagnetic switch 19 to the on-state.

Thus, the current flows from the battery 15 to the motor 17 without passing through the resistor 27d of the ICR relay 27, and the motor 17 rotates. By the rotational force of the motor 17, the pinion gear 21 rotates the ring gear 25, i.e., cranks the engine 1.

If the engine 1 is cranked, another ECU controlling the engine 1 performs fuel injection and ignition of the engine 1. If the engine 1 is a diesel engine, the ignition is not performed but only the fuel injection is performed. Alternatively, the ECU 11 may perform also such the control of the engine 1.

If the microcomputer 41 determines that the engine 1 has reached a complete explosion state (i.e., state where engine start has been completed, or state where engine 1 has been started-up), the microcomputer 41 switches off the transistors 51, 52. Thus, the energization to the motor 17 is stopped, and the pinion gear 21 is returned to the initial position where the pinion gear 21 is disengaged from the ring gear 25. The microcomputer 41 calculates engine rotation speed from the rotation signal and determines whether the engine 1 has reached the complete explosion state based on the engine rotation speed.

The above is the contents of the starter control at an initial engine start for starting the engine 1 initially. The state where the engine 1 is operating is shown by (2) in FIG. 2.

If the microcomputer 41 determines that a predetermined automatic stop condition is satisfied during the engine operation, the microcomputer 41 automatically stops the engine 1 by stopping the fuel injection to the engine 1 or blocking an intake air supply route to the engine 1. The state where the engine 1 is stopped automatically in this way (i.e., idle reduction state) is shown by (3) in FIG. 2.

The automatic stop condition is satisfied when all of following conditions (i) to (vii) are satisfied, for example.

(i) The battery voltage VB is equal to or higher than a predetermined value.

(ii) The vehicle speed is equal to or lower than a predetermined value.

(iii) An absolute value of the brake negative pressure is equal to or higher than a predetermined value.

(iv) The brake pedal is stepped on.

(v) The shift position is a neutral position or the shift position is other than the neutral position and the clutch pedal is stepped on.

(vi) The accelerator pedal is not stepped on.

(vii) At least a predetermined time has elapsed after the engine 1 is stopped automatically and restarted previously.

Thereafter, if the microcomputer 41 determines that a predetermined automatic start condition is satisfied during the idle reduction, the microcomputer 41 causes the starter 13 to crank the engine 1 in order to restart the engine 1. The state of the restart is shown in (4) of FIG. 2.

In concrete processing, the microcomputer 41 switches on the transistor 52 to engage the pinion gear 21 with the ring gear 25. The microcomputer 41 switches on the transistor 53 to bring the ICR relay 27 to the resistor side and switches on the transistor 51 to bring the electromagnetic switch 19 to the on-state. When a predetermined time elapses after that, the microcomputer 41 switches off the transistor 53 to bring the ICR relay 27 to the contact side while keeping the transistor 51 in the on-state (i.e., while keeping electromagnetic switch 19 at on-state).

Accordingly, first, the current flows from the battery 15 to the motor 17 through the resistor 27d of the ICR relay 27. Thus, the motor 17 begins to rotate while the inrush current to the motor 17 is suppressed. When the inrush current disappears, the ICR relay 27 switches from the resistor side to the contact side, and the current flows to the motor 17 without passing through the resistor 27d.

Also in such the restart of the engine 1, the motor 17 is energized and the pinion gear 21 rotates the ring gear 25 (i.e., engine 1 is cranked). Accordingly, the other ECU controlling the engine 1 performs the fuel injection and the ignition of the engine 1. When the microcomputer 41 determines that the engine 1 reaches the complete explosion state, the microcomputer 41 switches off the transistors 51, 52. Thus, the energization to the motor 17 is stopped and the pinion gear 21 is returned to the initial position where the pinion gear 21 is disengaged from the ring gear 25.

The above is the contents of the starter control at the engine restart from the idle reduction state. The automatic start condition may be one of following conditions (i) to (iii).

(i) The brake pedal is released when the idle reduction is performed in a state where the shift position is other than the neutral position and the clutch pedal is stepped on.

(ii) Release of the clutch pedal (i.e., operation for reducing stepping amount of clutch pedal to engage clutch) is started when the shift position is other than the neutral position while the brake pedal is stepped on.

(iii) The shift position is operated from the neutral position to the position other than the neutral position while the brake pedal is stepped on. The clutch pedal is stepped on at that time.

“STOP” in the right end of FIG. 2 indicates that the engine 1 has been stopped because the driver performs the operation to stop the engine 1. At that time, the ignition system power supply of the vehicle is also switched off.

In the present embodiment, the microcomputer 41 of the ECU 11 performs diagnostic processing (abnormality detection processing) for detecting a fixation abnormality (uncontrollable abnormality) of the ICR relay 27 at the initial start of the engine 1 ((1) in FIG. 2), during the operation of the engine 1 ((2) in FIG. 2), during the idle reduction of the engine 1 ((3) in FIG. 2), and at the restart of the engine 1 ((4) in FIG. 2).

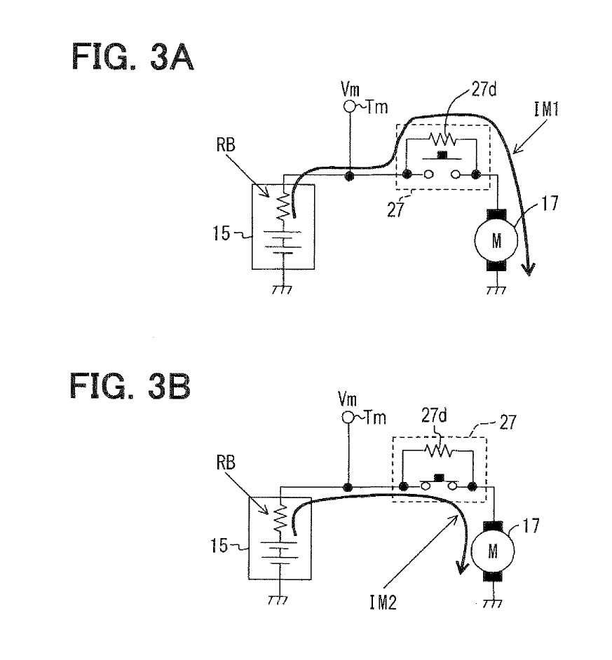

First, a detection principle of the fixation abnormality of the ICR relay 27 will be explained. FIG. 3A shows a route of the current in the case where the ICR relay 27 is set to the resistor side and the motor 17 is energized. FIG. 3B shows a route of the current in the case where the ICR relay 27 is set to the contact side and the motor 17 is energized.

In the case of FIG. 3A, the current flows to the motor 17 through the resistor 27d of the ICR relay 27. In the case of FIG. 3B, the resistor 27d becomes ineffective and the current flows to the motor 17 through the contacts 27b, 27c of the ICR relay 27. Therefore, the current IM1 (motor current) flowing to the motor 17 in the case of FIG. 3A is smaller than the motor current IM2 in the case of FIG. 3B. There is an impedance RB (internal impedance) in an inside of the battery 15 and is several milliohms in general.

The battery voltage VB in the case where the ICR relay 27 is driven to the resistor side (by energizing coil 27a) and the motor 17 is energized may be defined as VB1. The battery voltage VB in the case where the ICR relay 27 is driven to the contact side (by deenergizing coil 27a) and the motor 17 is energized may be defined as VB2. In this case, if the ICR relay 27 is normal, the battery voltage VB1 becomes higher than the battery voltage VB2. It is because the motor current IM1 is smaller than the motor current IM2 and the voltage drop inside the battery 15 is smaller in the case of the motor current IM1 than in the case of the motor current IM2.

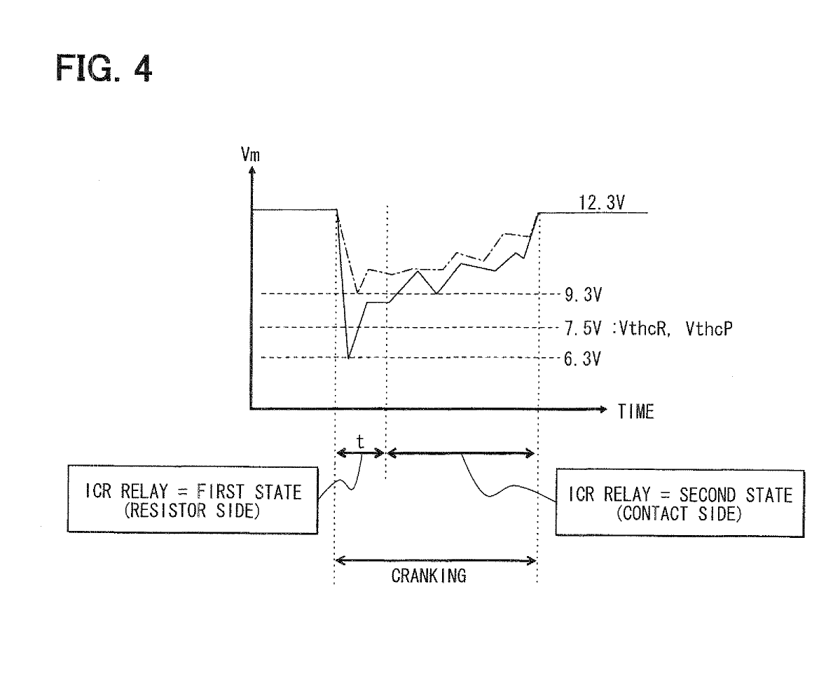

For example, a chained line in FIG. 4 shows a waveform of the monitor voltage Vm (=battery voltage VB) at the engine restart. The chained line shows the waveform of the monitor voltage Vm in the case where the starter 13 is caused to crank the engine 1 by passing the current to the motor 17 through the resistor 27d of the ICR relay 27 first and then by performing the control to pass the current to the motor 17 without passing the current through the resistor 27d when a predetermined time t elapses thereafter.

A solid line in FIG. 4 shows a waveform of the monitor voltage Vm at the initial engine start. The solid line shows the waveform of the monitor voltage Vm in the case where the starter 13 is caused to crank the engine 1 by performing the control for passing the current to the motor 17 without passing the current through the resistor 27d from the beginning.

As shown in FIG. 4, the minimum peak value of the monitor voltage Vm is smaller in the case of the solid line than in the case of the chained line because the inrush current of the motor 17 is larger in the case of the solid line than in the case of the chained line. In the example of FIG. 4, the concrete value of the battery voltage VB in the case where the motor 17 is deenergized is 12.3 V. The internal impedance RB of the battery 15 is 6 mΩ and the resistance of the resistor 27d is also 6 mΩ. The motor current at the cranking start in the case where the ICR relay 27 is on the contact side is 1000 A. The internal impedance of the motor 17 is ignored.

On such the premises, when the ICR relay 27 is on the contact side, the voltage drop inside the battery 15 is 6 V (=1000 A×6 mΩ), and the monitor voltage Vm decreases to 6.3 V (=12.3 V−6 V). When the ICR relay 27 is on the resistor side, the resistance (=6 mΩ) of the resistor 27d is added to the power supply line to the motor 17. Thus, the motor current halves from 1000 A to 500 A, and the voltage drop inside the battery 5 becomes 3 V (=500 A×6 mΩ). Therefore, the minimum peak value of the monitor voltage becomes 9.3 V (=12.3 V−3 V).

Therefore, in FIG. 4, while the minimum peak value of the monitor voltage Vm shown by the solid line is 6.3 V, the minimum peak value of the monitor voltage Vm shown by the chained line is 9.3 V. Base on this voltage difference, it can be determined whether the ICR relay 27 is on the resistor side or the contact side.

Therefore, in the present embodiment, if the monitor voltage Vm in the case where the ICR relay 27 is driven to the resistor side and the motor 17 is energized becomes lower than a predetermined determination value, it is determined that a fixation abnormality (contact side fixation abnormality), in which the ICR relay 27 remains on the contact side, has occurred.

If the monitor voltage Vm in the case where the ICR relay 27 is driven to the contact side and the motor 17 is energized does not become lower than a predetermined determination value, it is determined that a fixation abnormality (resistor side fixation abnormality), in which the ICR relay 27 remains on the resistor side, has occurred.

A normal value of the minimum peak value of the monitor voltage Vm (9.3 V in FIG. 4) in the case where the ICR relay 27 is switched to the resistor side and the motor 17 is energized may be defined as a value Vp1. A normal value of the minimum peak value of the monitor voltage Vm (6.3 V in FIG. 4) in the case where the ICR relay 27 is switched to the contact side and the motor 17 is energized may be defined as a value Vp2. In this case, both of the above-mentioned determination values may be set between the values Vp1, Vp2.

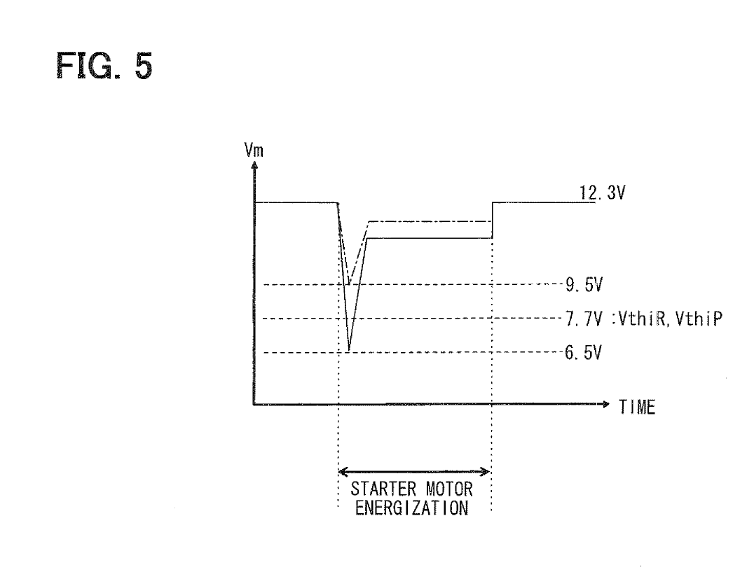

FIG. 5 shows another drive example than FIG. 4. A chained line in FIG. 5 shows a waveform of the monitor voltage Vm in the case where the motor 17 is energized while the pinion gear 21 is set at the initial position and the ICR relay 27 is maintained to the resistor side. A solid line in FIG. 5 shows a waveform of the monitor voltage Vm in the case where the motor 17 is energized while the pinion gear 21 is set at the initial position and the ICR relay 27 is maintained to the contact side. When only the energization to the motor 17 is performed without cranking the engine 1 with the starter 13 (i.e., when motor 17 is idled away), a rotation load of the motor 17 decreases and the motor current decreases correspondingly as understood from FIG. 5. Therefore, the monitor voltage Vm at the time when the motor 17 is energized becomes slightly higher than in the case of FIG. 4.

Next, in view of the above, concrete contents of the diagnostic processing performed by the microcomputer 41 will be explained with reference to flowcharts shown in FIGS. 6 to 10. FIG. 6 is a flowchart showing diagnostic processing at initial start. The diagnostic processing at initial start is started when the driver of the vehicle performs the starting operation and the starter signal becomes the active level in the initial start of the engine 1.

If the microcomputer 41 starts the diagnostic processing at initial start, the microcomputer 41 drives the ICR relay 27 to the contact side by maintaining the transistor 53 at the off state (i.e., by deenergizing coil 27a) in S110. In following S120, the microcomputer 41 switches on the transistor 52 to engage the pinion gear 21 with the ring gear 25. In following S130, the microcomputer 41 switches on the transistor 51 to switch on the electromagnetic switch 19 and to start the energization to the motor 17. Accordingly, the current flows to the motor 17 without passing through the resistor 27d of the ICR relay 27, whereby the cranking of the engine 1 starts.

In following S140, the minimum peak value of the monitor voltage Vm is sensed by performing the A/D conversion of the monitor voltage Vm multiple times at predetermined short intervals. It is determined whether the minimum peak value is lower than a determination value VthcR for the resistor side fixation abnormality determination. If the minimum peak value of the monitor voltage Vm is lower than the determination value VthcR (i.e., if monitor voltage Vm becomes lower than determination value VthcR), it is determined that the ICR relay 27 is normal (i.e., ICR 27 is on contact side as driven) in S150. In following S160, normal start control processing for initial engine start is performed.

Next, an example of the sensing procedure of the minimum peak value of the monitor voltage Vm will be explained. First, a first monitor voltage Vm(t0) having undergone the A/D conversion after the processing of S140 is stored in the memory 42 of the microcomputer 41. Then, a monitor voltage Vm(t1) having undergone the A/D conversion and obtained after a predetermined short interval (t1) is compared with the first monitor voltage Vm(t0) stored in the memory 42. If the monitor voltage Vm(t1) is smaller than the monitor voltage Vm(t0), the monitor voltage Vm(t0) stored in the memory 42 is erased and overwritten with the monitor voltage Vm(t1). If the monitor voltage Vm(t1) is not smaller than the monitor voltage Vm(t0), the monitor voltage Vm(t0) stored in the memory 42 is maintained. The value stored in the memory 42 after the above processing is repeated multiple times is the minimum peak value of the monitor voltage Vm. That is, every time the A/D conversion is performed, it is determined whether the monitor voltage Vm obtained by the A/D conversion is smaller than the monitor voltage Vm stored in the memory 42. The smaller value is stored in the memory 42. The sensing method of the minimum peak value of the monitor voltage Vm is not limited to the above-described example. Alternatively, results of multiple times of the A/D conversion of the monitor voltage Vm may be stored in the memory 42 and a sorting algorithm such as quick sorting or merging sorting may be used to sense the minimum peak value. Alternatively, a peak hold circuit may be used.

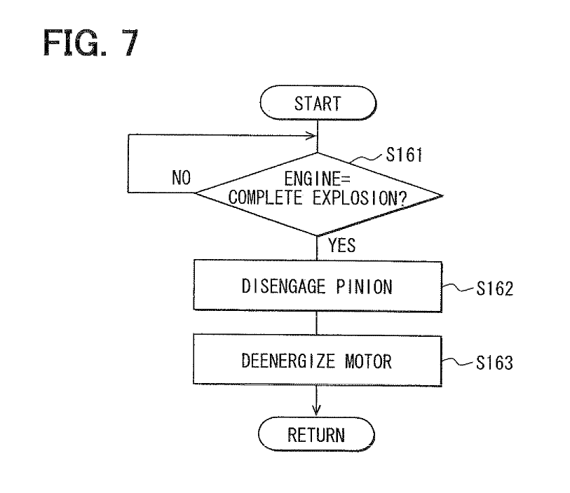

The normal start control processing of S160 is remaining processing for realizing the starter control contents at the initial engine start together with the processing from S110 to S130. Next, the normal start control processing for initial engine start will be explained with reference to FIG. 7. It is determined whether the engine 1 has reached a complete explosion state in S161. If it is determined that the engine 1 has reached the complete explosion state, the transistor 52 is switched off in S162, and the transistors 51 is switched off in S163. Thus, the energization to the motor 17 is stopped and the pinion gear 21 is returned to the initial position where the pinion gear 21 is disengaged from the ring gear 25. If the above normal start control for initial engine start ends, the diagnostic processing at initial start also ends. It can be determined that the engine 1 reaches the complete explosion state when the engine rotation speed becomes a predetermined rotation speed or over.

The determination value VthcR used in S140 is a voltage between 9.3 V (=Vp1) and 6.3 V (=Vp2) as shown in FIG. 4. The determination value VthcR is set at 7.5 V, for example. In S140, the A/D conversion of the monitor voltage Vm may be performed once when a time, during which the battery voltage VB is anticipated to minimize, passes after the energization to the motor 17 is started. The value obtained by the A/D conversion may be used as the minimum peak value of the monitor voltage Vm.

If it is determined that the minimum peak value of the monitor voltage Vm is not smaller than the determination value VthcR in S140 (i.e., if monitor voltage Vm does not become smaller than determination value VthcR), the process proceeds to S170. In S170, it is determined that the resistor side fixation abnormality has occurred in the ICR relay 27, and an error flag FRERR indicating the occurrence of the resistor side abnormality is set at 1.

In following S180, informing processing for informing the vehicle driver of the occurrence of the resistor side fixation abnormality is performed. As the informing processing, a warning lamp (indicator) is lit, a buzzer is set off, or a message is displayed to urge the vehicle driver to go to a car dealer of the like, for example. Further, in following S190, an idle reduction prohibition flag FSTPD for prohibiting the idle reduction is set at 1.

Thus, even if the automatic stop condition is established during the operation of the engine 1 thereafter, the idle reduction is no longer performed. More specifically, when the idle reduction prohibition flag FSTPD is set at 1, the microcomputer 41 does not determine the establishment of the automatic stop condition or the microcomputer 41 does not perform the processing for stopping the engine 1 even if it is determined that the automatic stop condition is established.

In following S200, it is determined whether the energization time of the motor 17 (i.e., elapsed time after energization to motor 17 is started in S130) has become equal to or longer than a predetermined time ta. If the energization time becomes equal to or longer than the predetermined time ta, the process proceeds to S210. In S210, the transistor 52 is switched off to return the pinion gear 21 to the initial position. In following S220, the transistor 51 is switched off to switch off the electromagnetic switch 19 and to stop the energization to the motor 17. Accordingly, the cranking of the engine 1 stops and the diagnostic processing at initial start also ends.

If the motor 17 is energized for a long time when the resistor side fixation abnormality exists in the ICR relay 27, there is a possibility that the resistor 27d burns out. If the resistor 27d breaks, the engine start by energizing the motor 17 cannot be performed thereafter. Therefore, in order to prevent such the situation, the processing of S200 to S220 is performed to restrict the energization time of the motor 17 to the predetermined time.

In this way, there is a possibility that the engine 1 cannot be started when the resistor side fixation abnormality occurs in the ICR relay 27. Therefore, specifically, it is desirable to provide the driver with a message (display, sound or the like) to urge the driver to go to the car dealer or the like without stopping the engine 1 as the informing processing in S180.

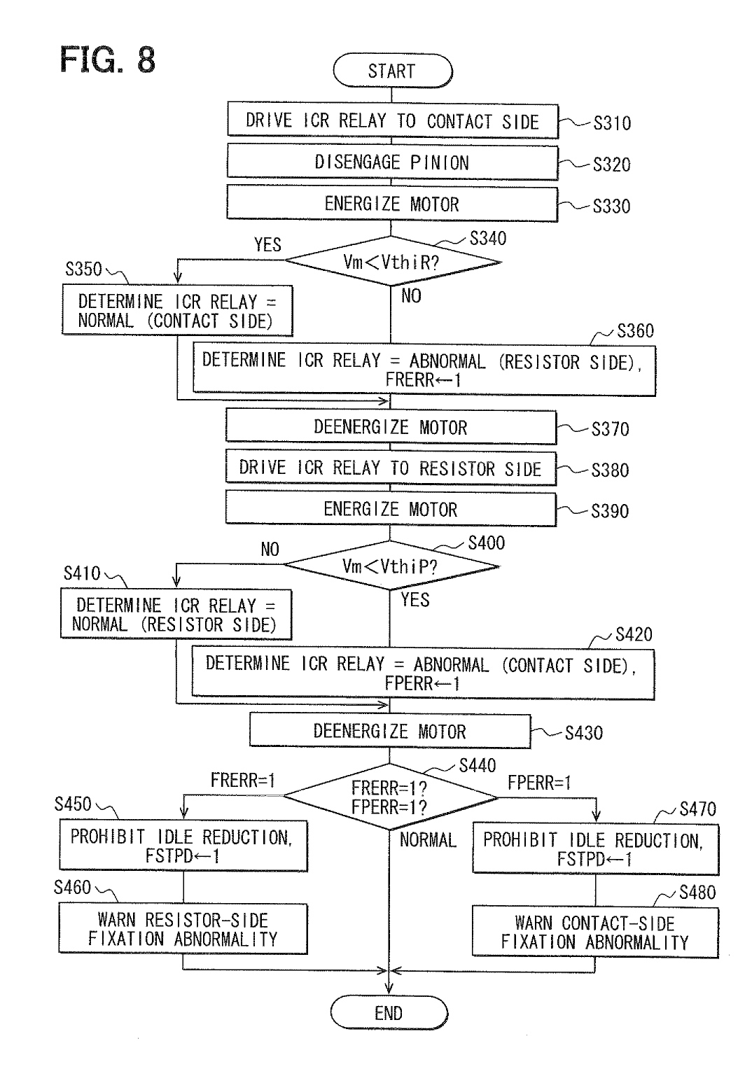

FIG. 8 is a flowchart showing diagnostic processing during engine operation. The diagnostic processing during engine operation is performed at every constant time interval during the operation of the engine 1. If the microcomputer 41 starts the diagnostic processing during engine operation, the ICR relay 27 is driven to the contact side (i.e., coil 27a is deenergized) by maintaining the transistor 53 at the off-state in S310. In following S320, the pinion gear 21 is maintained at the initial position by maintaining the transistor 52 at the off-state. In following S330, the transistor 51 is switched on to bring the electromagnetic switch 19 to the on-state, thereby starting the energization to the motor 17. Thus, the current flows to the motor 17 without passing through the resistor 27d of the ICR relay 27, whereby the motor 17 rotates. However, since the pinion gear 21 is in the initial position, the engine 1 is not cranked. That is, the ICR relay 27 is driven to the contact side to idle away the motor 17.

In following S340, the minimum peak value of the monitor voltage Vm is sensed as in S140 of FIG. 6. It is determined whether the minimum peak value is lower than a determination value VthiR for the resistor side fixation abnormality determination. If the minimum peak value of the monitor voltage Vm is lower than the determination value VthiR (i.e., if monitor voltage Vm becomes lower than determination value VthiR), it is determined in S350 that the ICR relay 27 is normal (i.e., ICR relay 27 is on contact side as driven), and the process proceeds to S370.

The determination value VthiR is a voltage between 9.5 V and 6.5 V shown in FIG. 5. For example, the determination value VthiR is set at 7.7 V. The determination value VthiR is set at a value slightly higher than the determination value VthcR (=7.5 V) used in S140 of FIG. 6. That is, in FIG. 5, 9.5 V is a normal value of the minimum peak value of the monitor voltage Vm in the case where the motor 17 is idled while setting the ICR relay 27 to the resistor side. 6.5 V is a normal value of the minimum peak value of the monitor voltage Vm in the case where the motor 17 is idled while setting the ICR relay 27 to the contact side. Both the normal values (9.5 V, 6.5 V) are higher than the values (9.3 V, 6.3 V) as of the cranking shown in FIG. 4. Therefore, the determination value VthiR in the case where the motor 17 is idled is set at a value slightly larger than the determination value VthcR as of the cranking. In other words, the determination value VthcR as of the cranking is set at a smaller than the determination value VthiR in the case there the motor 17 is idled. This is the same also in the case of determination values VthiP, VthcP mentioned later. Alternatively, the determination value in the case where the motor 17 is idled may be set at the same value as the determination value as of the cranking.

If it is determined that the minimum peak value of the monitor voltage Vm is not lower than the determination value VthiR in S340 (i.e., if monitor voltage Vm does not become lower than determination value VthiR), the process proceeds to S360. In S360, it is determined that the resistor side fixation abnormality has occurred in the ICR relay 27, and the error flag FRERR indicating the occurrence of the resistor side fixation abnormality is set at 1. Thereafter, the process proceeds to S370.

In S370, the transistor 51 is switched off to stop the energization to the motor 17 once. In following S380, the transistor 53 is switched on to drive the ICR relay 27 to the resistor side (i.e., to energize coil 27a). In following S390, the transistor 51 is switched on to start the energization to the motor 17. Thus, this time, the current flows to the motor 17 through the resistor 27d of the ICR relay 27 and the motor 17 rotates. However, since the pinion gear 21 is in the initial position, the engine 1 is not cranked. That is, the ICR relay 27 is set to the resistor side and the motor 17 is idled away.

In following S400, the minimum peak value of the monitor voltage Vm is sensed as in S140 of FIG. 6. It is determined whether the minimum peak value is lower than the determination value VthiP for the contact side fixation abnormality determination. If it is determined that the minimum peak value of the monitor voltage Vm is not lower than the determination value VthiP (i.e., if monitor voltage Vm does not become lower than determination value VthiP), it is determined that the ICR relay 27 is normal in S410 (i.e., ICR relay 27 is on resistor side as driven), and the process proceeds to S430. The determination value VthiP used in S400 of the present embodiment is the same value as the determination value VthiR used in S340 (refer to FIG. 5).

The process proceeds to S420 when it is determined that the minimum peak value of the monitor voltage Vm is lower than the determination value VthiP in S400 (i.e., when monitor voltage Vm becomes lower than determination value VthiP). In S420, it is determined that the contact side fixation abnormality has occurred in the ICR relay 27, and an error flag FPERR indicating occurrence of the contact side fixation abnormality is set at 1. Then, the process proceeds to S430.

In S430, the transistor 51 is switched off to stop the energization to the motor 17. In following S440, the abnormality determination of the ICR relay 27 is performed. More specifically, both of the error flag FRERR and the error flag FPERR are referred to. If both of the error flags FRERR, FPERR are 0, the diagnostic processing during engine operation is ended as it is. If the error flag FRERR is 1, the process proceeds to S450, in which the idle reduction prohibition flag FSTPD is set at 1. In following S460, the informing processing similar to S180 of FIG. 6 is performed. Then, the diagnostic processing during engine operation is ended.

If the error flag FPERR is 1, the process proceeds to S470, in which the idle reduction prohibition flag FSTPD is set at 1. In following S480, informing processing for informing the vehicle driver of the occurrence of the contact side fixation abnormality is performed. Then, the diagnostic processing during engine operation is ended. As the informing processing in S480, the warning lamp (indicator) is lit, the buzzer is set off, or the message is displayed to urge the vehicle driver to go to the car dealer of the like, for example.

The microcomputer 41 performs the same processing as FIG. 8 also during the idle reduction. The processing performed during the idle reduction will be referred to as diagnostic processing during idle reduction. Also the diagnostic processing during idle reduction may be performed at every constant interval. It is desirable to perform the diagnostic processing during idle reduction at least immediately after the idle reduction is started. Thus, the diagnosis of the ICR relay 27 can be performed at least once during the idle reduction regardless of the timing when the automatic start condition is established.

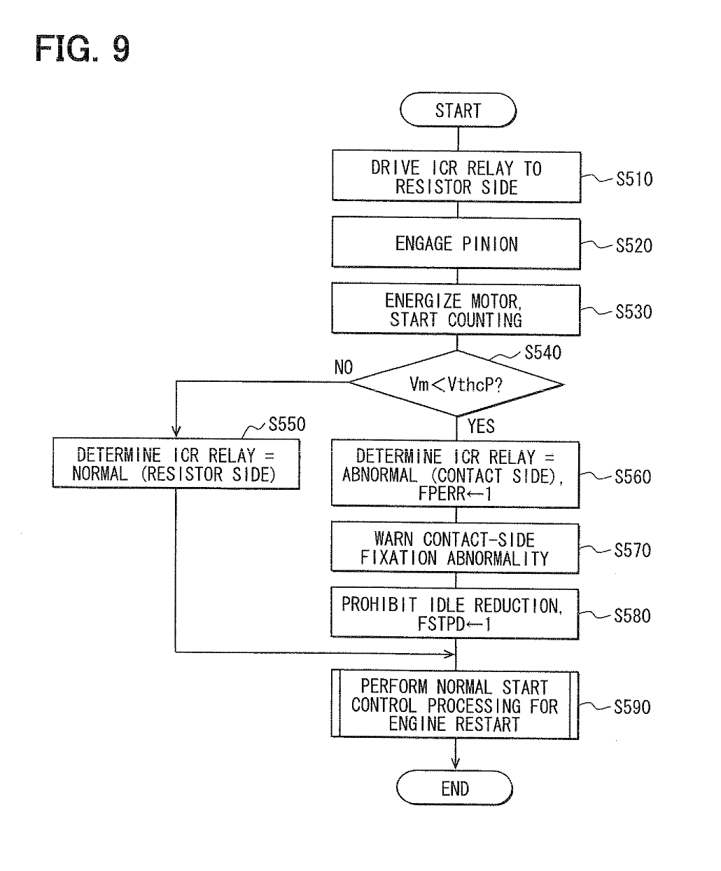

FIG. 9 is a flowchart showing diagnostic processing at restart. The diagnostic processing of FIG. 9 is performed at the restart of the engine 1. That is, if the microcomputer 41 determines that the automatic start condition is established during the idle reduction, the microcomputer 41 performs the diagnostic processing at restart.

First in S510, the transistor 53 is switched on to drive the ICR relay 27 to the resistor side (i.e., to energize coil 27a). In following S520, the transistor 52 is switched on to engage the pinion gear 21 with the ring gear 25. In following S530, the transistor 51 is switched on to bring the electromagnetic switch 19 to the on-state, thereby starting the energization to the motor 17. Thus, the current flows to the motor 17 through the resistor 27d of the ICR relay 27, whereby the cranking of the engine 1 (cranking for restart from idle reduction) starts.

In following S540, the minimum peak value of the monitor voltage Vm is sensed as in S140 of FIG. 6. It is determined whether the minimum peak value is lower than the determination value VthcP for the contact side fixation abnormality determination. If the minimum peak value of the monitor voltage Vm is not lower than the determination value VthcP (i.e., if monitor voltage Vm does not become lower than determination value VthcP), it is determined that the ICR relay 27 is normal (i.e., ICR relay is on resistor side as driven) in S550, and the process proceeds to S590. The determination value VthcP used in S540 is the same value as the determination value VthcR used in S140 of FIG. 6 (refer to FIG. 4). The determination value VthcP used in S540 is the value smaller than the determination value VthiP (refer to FIG. 5). It is because the cranking is performed also in this case as in the case of FIG. 4.

If it is determined that the minimum peak value of the monitor voltage Vm is lower than the determination value VthcP in S540 (i.e., if monitor voltage Vm becomes lower than determination value VthcP), the process proceeds to S560. In S560, it is determined that the contact side fixation abnormality has occurred in the ICR relay 27, and the error flag FPERR indicating the occurrence of the contact side abnormality is set at 1. In following S570, informing processing for informing the vehicle driver of the occurrence of the contact side fixation abnormality is performed like S480 of FIG. 8. In following S580, the idle reduction prohibition flag FSTPD is set at 1 to prohibit the idle reduction thereafter. Then, the process proceeds to S590.

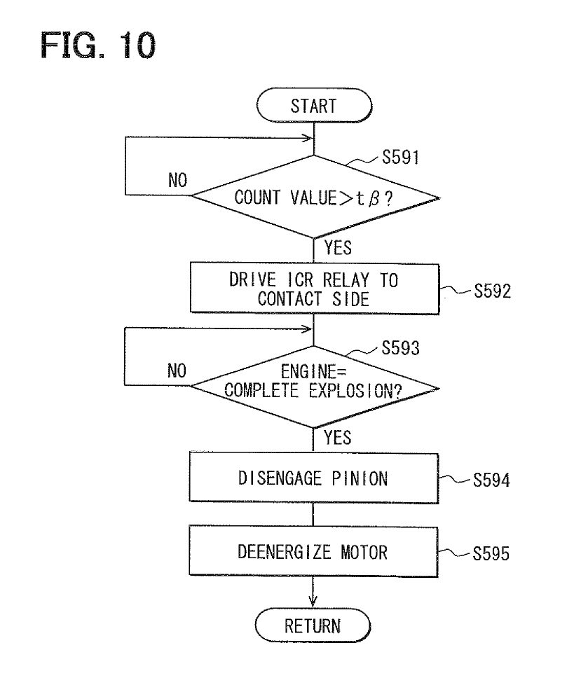

Normal start control processing for the engine restart is performed in S590. The normal start control processing in S590 is remaining processing for realizing the starter control contents at the time of the engine restart together with the processing from S510 to S530. Next, the normal start control processing for the engine restart will be explained with reference to FIG. 10. First, it is determined in S591 whether a predetermined time tβ has elapsed after the energization to the motor 17 is started in S530. If the predetermined time tβ elapses, the process proceeds to S592. In S592, while keeping the transistor 51 in the on-state, the transistor 53 is switched off to drive the ICR relay 27 to the contact side. In S593 following S592, it is determined whether the engine 1 has reached the complete explosion state. If it is determined that the complete explosion state has been reached, the transistor 52 is switched off in S594, and the transistors 51 is switched off in S595. Thus, the energization to the motor 17 is stopped and the pinion gear 21 is returned to the initial position where the pinion gear 21 is disengaged from the ring gear 25. If such the normal start control ends, the diagnostic processing at restart also ends.

With such the ECU 11, the resistor side fixation abnormality of the ICR relay 27 can be detected before the restart of the engine 1 by the processing from S310 to S370 of FIG. 8 (corresponding to first state fixation abnormality detection processing at non-start timing) performed during the operation of the engine 1 and the idle reduction. Likewise, the contact side fixation abnormality of the ICR relay 27 can be detected before the restart of the engine 1 by the processing of S320 and S380 to S430 of FIG. 8 (corresponding to second state fixation abnormality detection processing at non-start timing) performed during the operation of the engine 1 and the idle reduction.

By the processing of S140, S150 and S170 of FIG. 6 (corresponding to first state fixation abnormality detection processing at initial start) performed at the initial start of the engine 1, the resistor side fixation abnormality of the ICR relay 27 can be detected without energizing the motor 17 only for the abnormality detection.

By the processing of S540 to S560 of FIG. 9 (corresponding to second state fixation abnormality detection processing at restart) performed at the restart of the engine 1, the contact side fixation abnormality of the ICR relay 27 can be detected without energizing the motor 17 only for the abnormality detection.

If the fixation abnormality of either one of the contact side and the resistor side of the ICR relay 27 is detected, the execution of the idle reduction is prohibited (S190, S450, S470, S580). Therefore, when the contact side fixation abnormality of the ICR relay 27 occurs, the problem that the inrush current to the motor 17 cannot be suppressed in the restart of the engine 1 so that the battery voltage decreases and some ECU is reset can be precluded. In addition, when the resistor side fixation abnormality of the ICR relay 27 occurs, the problem that the resistor 27d of the ICR relay 27 burns out in the engine restart can be precluded.

If the fixation abnormality of either one of the contact side and the resistor side of the ICR relay 27 is detected, the occurrence of the abnormality is informed to the driver (S180, S460, S480, S570). Therefore, early repair can be urged to the driver.

If it is determined that the resistor side fixation abnormality exists in the ICR relay 27 in S170 of FIG. 6 in the initial start of the engine 1, the energization time of the motor 17 in the present initial start is limited to the predetermined time (S200 to S220). Thus, the resistor 27d can be prevented from burning out.

The determination values VthcR, VthcP in the case where the cranking is performed are set at the values different from the determination values VthiR, VthiP in the case where the motor 17 is idled away. The former determination values VthcR, VthcP are set at the smaller values than the latter determination values VthiR, VthiP. Therefore, the determination accuracy of the fixation abnormality of each case can be improved.

The fixation abnormality of the ICR relay 27 is detected based on the battery voltage VB (which is one of automatic stop conditions), monitoring of which is necessary for performing the idle reduction control. Therefore, there is no need to newly add a circuit for monitoring a signal only for detecting the fixation abnormality.

The processing of FIG. 8 may be performed in only either one of the operation of the engine 1 and the idle reduction. That is, only either one of the diagnostic processing during engine operation and the diagnostic processing during idle reduction may be performed.

It is preferable to perform either one or both of the diagnostic processing during engine operation and the diagnostic processing during idle reduction when the vehicle speed is higher than 0. It is because the motor 17 is energized under the situation where there is essentially no need to energize the motor 17 and therefore the operation sound of the motor 17 should not be preferably audible to the occupant of the vehicle. If the vehicle speed is not zero, it is thought that the operation sound of the motor 17 is less audible due to the running sound of the vehicle. Therefore, it is desirable to perform the diagnostic processing under the situations where the sound is less distinguishable such as acceleration of the vehicle, deceleration of the vehicle and high-speed running of the vehicle.

When a device using a large energization current such as a defogger, a blower or a head lump is in operation, the diagnostic processing during engine operation or the diagnostic processing during idle reduction further increases an electric load by rotating the motor 17. Therefore, in such the case, either or both of the diagnostic processing during engine operation and the diagnostic processing during idle reduction may be suspended.

The diagnostic processing during idle reduction may be suspended in order to prioritize suppression of battery consumption during the idle reduction. Specifically, during the stoppage of the engine 1, vibration of the vehicle is small. Therefore, it is thought that the ICR relay 27 hardly changes from the normal state to the fixation abnormality state during the stoppage of the engine 1. Therefore, the diagnostic processing during idle reduction may be suspended or may be performed only once immediately after the idle reduction is started.

If the automatic start condition is established while the diagnostic processing during idle reduction is performed, the diagnostic processing during idle reduction may be aborted immediately such that the processing of FIG. 9 is started. Thus, delay of the restart can be prevented.

In the present embodiment, the ECU 11 corresponds to a starter controller. The electromagnetic switch 19 corresponds to a switching section. The ICR relay 27 corresponds to an inrush current suppressing section. The microcomputer 41 also corresponds to an idle reduction controlling section. The processing of S510, S530 and S590 in FIG. 9 corresponds to restart energization processing. The processing of S110, S130 and S160 in FIG. 6 corresponds to initial start energization processing.

Each of the processing of S140, S150, S170 and S200 to S220 in FIG. 6, the processing of S310 to S440 in FIG. 8 and the processing of S540 to S560 in FIG. 9 correspond to processing as an abnormality detecting section.

As already mentioned above, in the processing as the abnormality detecting section, the processing of S320 and S380 to S430 in FIG. 8 corresponds to the second state fixation abnormality detection processing at non-start timing. The processing of S540 to S560 in FIG. 9 corresponds to the second state fixation abnormality detection processing at restart. The processing of S310 to S370 in FIG. 8 corresponds to the first state fixation abnormality detection processing at non-start timing. The processing of S140, S150 and S170 in FIG. 6 corresponds to the first state fixation abnormality detection processing at initial start. The determination value VthiP of S400 corresponds to a first determination value for second state fixation. The determination value VthcP of S540 corresponds to a second determination value for second state fixation. The determination value VthiR of S340 corresponds to a first determination value for first state fixation. The determination value VthcR of S140 corresponds to a second determination value for first state fixation.

Each of the processing of S470 in FIG. 8 and the processing of S580 in FIG. 9 corresponds to a first prohibiting section. Each of the processing of S480 in FIG. 8 and the processing of S570 in FIG. 9 corresponds to a first informing section. Each of the processing of S190 in FIG. 6 and the processing of S450 in FIG. 8 corresponds to a second prohibiting section. Each of the processing of S180 in FIG. 6 and the processing of S460 in FIG. 8 corresponds to a second informing section.

### Second Embodiment

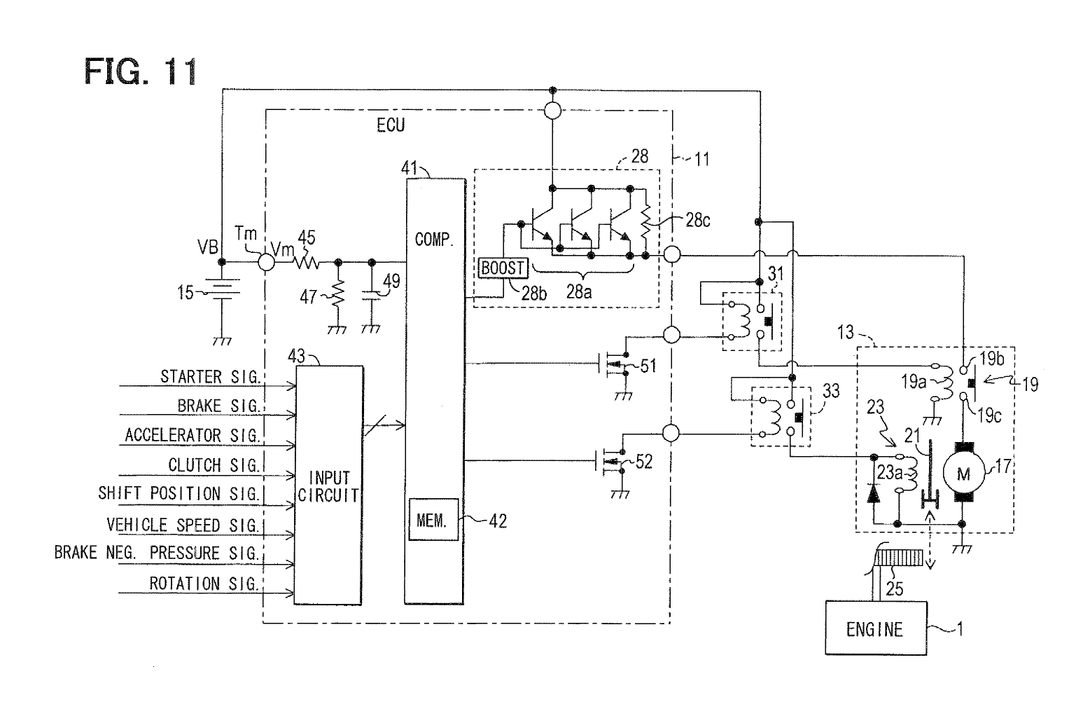

Next, a second embodiment of the present invention will be explained. As shown in FIG. 11, in the second embodiment, the ICR relay 27 is not provided outside the ECU 11 unlike the first embodiment. Instead, an inrush current suppression circuit 28 that has the same function as the ICR relay 27 is provided inside the ECU 11.

The inrush current suppression circuit 28 has a transistor group 28a provided in series between the output terminal of the ECU 11 connected to the contact 19b of the electromagnetic switch 19 and the line of the battery voltage VB inside the ECU 11. The inrush current suppression circuit 28 further has a booster circuit 28b for switching on the transistor group 28a and a resistor 28c provided in parallel to the transistor group 28a between the output terminal of the ECU 11 and the line of the battery voltage VB inside the ECU 11.

The transistor group 28a consists of multiple transistors parallel to each other. In the present embodiment, each transistor is an IGBT, for example. The booster circuit 28b generates a high voltage higher than the battery voltage VB from the battery voltage VB. The booster circuit 28b supplies the high voltage to gates of the transistor group 28a according to a command from the microcomputer 41, thereby switching on the transistor group 28a.

Therefore, if the transistor group 28a is not switched on (i.e., is switched off), the inrush current suppression circuit 28 is brought to a first state, in which the resistor 28c is inserted into the power supply line leading to the motor 17 in series. If the transistor group 28a is switched on, the inrush current suppression circuit 28 is brought to a second state, in which the power supply line leading to the motor 17 is connected without inserting the resistor 28c into the power supply line.

Therefore, in the second embodiment, the ECU 11 does not have the transistor 53 for driving the ICR relay 27. The microcomputer 41 of the ECU 11 performs following processing, in which the processing of S110, S310, S380 and S510 of FIGS. 6, 8 and 9 is modified, instead of the processing of FIGS. 6, 8 and 9.

That is, in S110 of FIGS. 6 and S310 of FIG. 8, the transistor group 28a is switched on instead of driving the ICR relay 27 to the contact side. In S380 of FIGS. 8 and S510 of FIG. 9, the transistor group 28a is switched off instead of driving the ICR relay 27 to the resistor side.

The second embodiment constructed in this way exerts the same effects as the effects of the first embodiment. A switching element other than the IGBT may be used as the transistor constituting the transistor group 28a. For example, a FET or a bipolar transistor may be used. Instead of the transistor group 28a, a single transistor (switching element) may be used as long as a large current can be passed to the motor 17.

### Third Embodiment

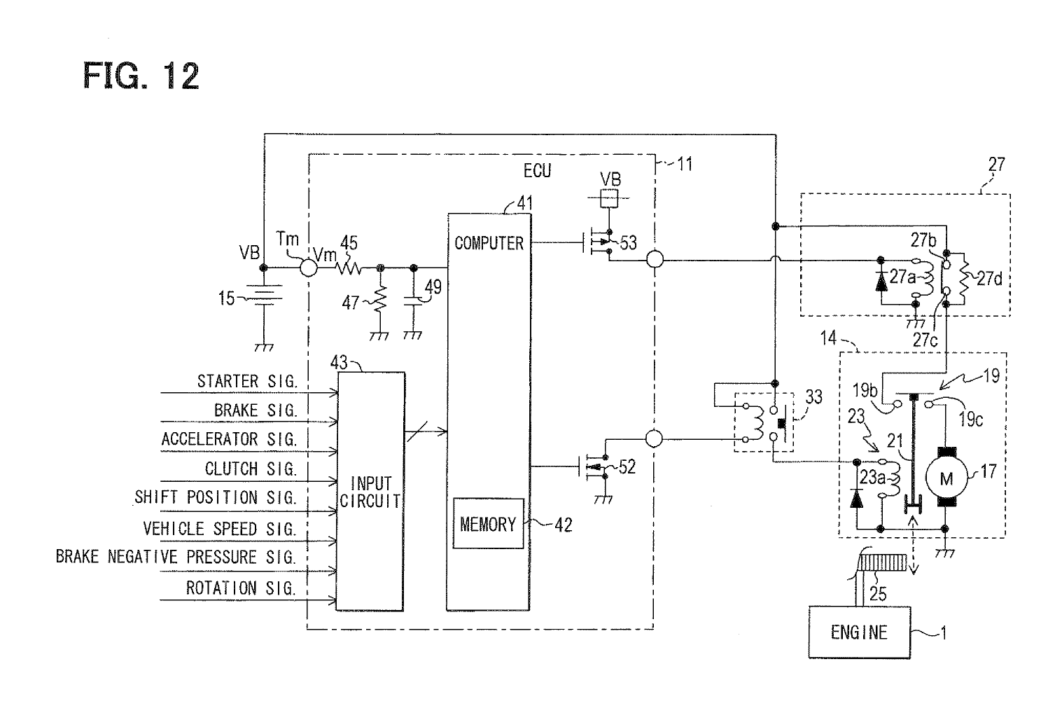

Next, a third embodiment of the present invention will be described. As shown in FIG. 12, in the third embodiment, a starter 14 is used in place of the starter 13 of the first embodiment. The starter 14 is constructed such that the action for engaging the pinion gear 21 with the ring gear 25 and the energization to the motor 17 are performed in conjunction with each other. That is, the starter 14 cannot operate the pinion gear 21 and the motor 17 independently from each other. The starter 14 is a reinforced starter that has reinforced parts and that has an increased operable time number as compared to a starter mounted on a vehicle that does not perform the idle reduction.

More specifically, if the coil 23a of the pinion actuation solenoid 23 of the starter 14 is energized, the pinion gear 21 protrudes and engages with the ring gear 25. In addition, due to an electromagnetic force caused by the energization to the coil 23a, the contacts 19b, 19c of the electromagnetic switch 19 short-circuit to connect the power supply line to the motor 17.

Therefore, the electromagnetic switch 19 of the starter 14 does not have the coil 19a used in the first embodiment. The ECU 11 does not have the transistor 51 for driving only the electromagnetic switch 19. That is, in the starter 14, the coil 23a of the pinion actuation solenoid 23 functions also as the coil for switching on the electromagnetic switch 19.

Instead of the processing of FIG. 6, the microcomputer 41 of the ECU 11 performs the processing of FIG. 6, from which S130 and S220 are removed. Instead of the processing of FIG. 9, the microcomputer 41 performs the processing of FIG. 9, from which S530 is removed. It is because also the electromagnetic switch 19 is switched on and off by the on and off of the transistor 52 that operates the pinion gear 21.

Since the starter 14 is used in the third embodiment, the microcomputer 41 does not perform the diagnostic processing of FIG. 8 during the operation of the engine 1 and during the idle reduction. The ECU 11 according to the third embodiment exerts the same effects as the first embodiment except that the ECU 11 of the third embodiment cannot detect the abnormality of the ICR relay 27 during the operation of the engine 1 and the idle reduction.

### Fourth Embodiment

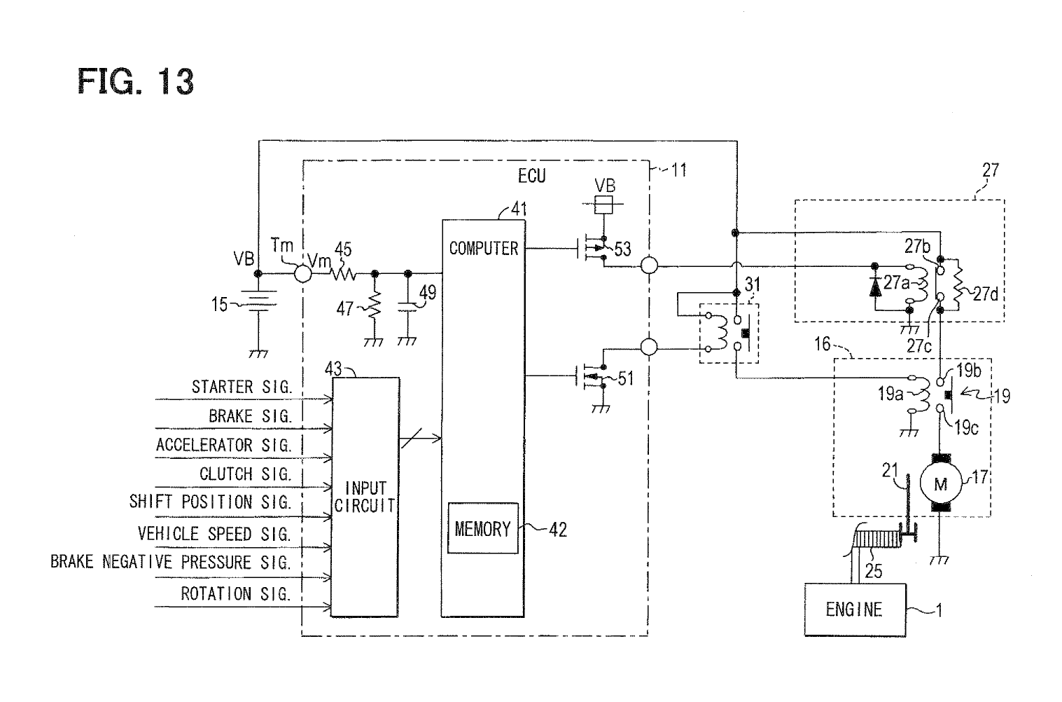

Next, a fourth embodiment of the present invention will be described. As shown in FIG. 13, in the fourth embodiment, a starter 16 is used in place of the starter 13 used in the first embodiment. The starter 16 is structured such that the pinion gear 21 invariably engages with the ring gear 25.

Therefore, the starter 16 does not have the pinion actuation solenoid 23. The ECU 11 does not have the transistor 52 for driving the pinion actuation solenoid 23. In the starter 16, a one-way clutch is provided between the pinion gear 21 and the rotary shaft of the motor 17. When the pinion gear 21 is rotated not by the motor 17 but by the ring gear 25 (i.e., when motor 17 is deenergized), the one-way clutch prevents the motor 17 from being rotated by a rotational force from the ring gear 25.

Instead of the processing of FIG. 6, the microcomputer 41 of the ECU 11 performs the processing of FIG. 6, from which S120 and S210 are removed. Instead of the processing of FIG. 8, the microcomputer 41 performs the processing of FIG. 8, from which S520 is removed. It is because the processing for controlling the pinion gear 21 of the starter 16 is unnecessary.

Since the starter 16 is used in the fourth embodiment, the microcomputer 41 does not perform the diagnostic processing of FIG. 7 during the operation of the engine 1 and during the idle reduction. Like the third embodiment, the ECU 11 according to the fourth embodiment exerts the same effects as the first embodiment except that the ECU 11 of the fourth embodiment cannot detect the abnormality of the ICR relay 27 during the operation of the engine 1 and the idle reduction.

### Fifth Embodiment

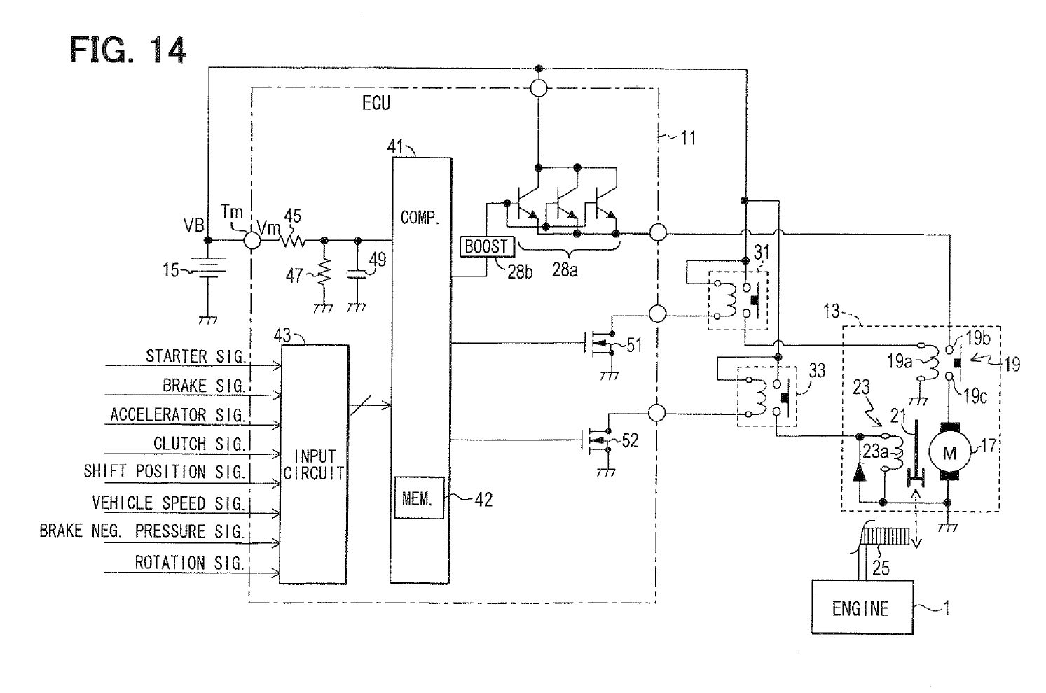

Next, a fifth embodiment of the present invention will be described. As shown in FIG. 14, in the fifth embodiment, the ICR relay 27 is not provided outside the ECU 11 unlike the first embodiment. A transistor group 28a that has the same function as the ICR relay 27 is provided inside the ECU 11.

The transistor group 28a consists of multiple transistors parallel to each other. For example, the transistor is an IGBT in the present embodiment. The transistor group 28a is provided in series between the output terminal of the ECU 11 connected to the contact 19b of the electromagnetic switch 19 and the line of the battery voltage VB inside the ECU 11.

The ECU 11 further has a booster circuit 28b for switching on the transistor group 28a. The booster circuit 28b generates a high voltage higher than the battery voltage VB from the battery voltage VB. The booster circuit 28b supplies the high voltage to gates of the transistor group 28a according to a command from the microcomputer 41, thereby switching on the transistor group 28a. Therefore, the ECU 11 does not have the transistor 53 for driving the ICR relay 27.

That is, the transistor group 28a and the booster circuit 28b according to the present embodiment are the same as the transistor group 28a and the booster circuit 28b of FIG. 11 mentioned above. However, the resistor 28c shown in FIG. 11 is not used in the fifth embodiment.

In the fifth embodiment, if the microcomputer 41 performs drive of switching control for switching the transistor group 28a between on and off, the transistor group 28a is brought to a first state for suppressing the energization current passed to the motor 17. If the microcomputer 41 performs drive for maintaining the on-state of the transistor group 28a (i.e., for maintaining transistor group 28a at on-state), the transistor group 28a is brought to a second state, in which the energization current passed to the motor 17 is not suppressed.

That is, performing the switching control of the transistor group 28a in the fifth embodiment corresponds to bringing the ICR relay 27 to the resistor side in the first embodiment. Maintaining the transistor group 28a in the on-state in the fifth embodiment corresponds to bringing the ICR relay 27 to the contact side in the first embodiment.

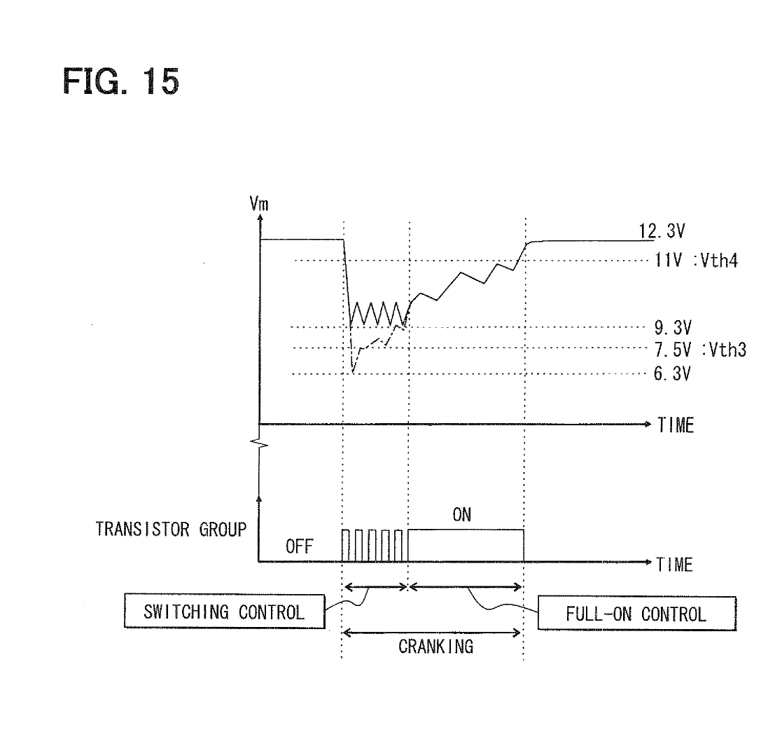

Therefore, the microcomputer 41 suppresses the inrush current flowing to the motor 17 by performing the switching control of the transistor group 28a until a predetermined time elapses after the energization to the motor 17 is started (i.e., after electromagnetic switch 19 is switched on) at the engine restart from the idle reduction as shown in a lower part of FIG. 15. The microcomputer 41 cancels the suppression of the energization current passed to the motor 17 by keeping the transistor group 28a in the on-state from the timing when the predetermined time elapses to the end timing of the energization to the motor 17. “FULL-ON CONTROL” in FIG. 15 and in following description means control for keeping the transistor group 28a in the on-state.

The microcomputer 41 keeps the transistor group 28a in the on-state (i.e., performs full-on control) from the start timing to the end timing of the energization to the motor 17 in the initial start for starting the engine 1 in response to the starting operation by the driver.

A solid line in an upper part of FIG. 15 shows a waveform of the monitor voltage Vm (=battery voltage VB) at the engine restart. The solid line shows the waveform of the monitor voltage Vm in the case where the electromagnetic switch 19 is switched on and the transistor group 28a is controlled as shown in the lower part of FIG. 15 while the pinion gear 21 is engaged with the ring gear 25. A chained line in the upper part of FIG. 15 shows a waveform of the monitor voltage Vm at the initial engine start. The chained line shows the waveform of the monitor voltage Vm in the case where the electromagnetic switch 19 is switched on and the full-on control of the transistor group 28a is performed from the beginning of the energization to the motor 17 while the pinion gear 21 is engaged with the ring gear 25.

As understood from FIG. 15, also in the fifth embodiment, the minimum peak value of the monitor voltage Vm in the case where the current is not suppressed as shown by the chained line becomes lower than in the case where the current is suppressed as shown by the solid line like the first embodiment.

For example, in the example of FIG. 15, while the minimum peak value of the monitor voltage Vm shown by the solid line is 9.3 V, the minimum peak value of the monitor voltage Vm shown by the chained line is 6.3 V. By the voltage difference, it can be determined whether the switching control of the transistor group 28a is performed or the transistor group 28a is continuously in the on-state.

If the monitor voltage Vm does not become lower than a predetermined determination value (for example, Vth4 in FIG. 15=11 V) although the electromagnetic switch 19 is switched on and the switching control or the full-on control of the transistor group 28a is performed, it can be determined that the current does not flow to the motor 17 and a fixation abnormality in the off-state has occurred in the transistor group 28a. The fixation abnormality in the off-state is an abnormality, in which the transistor group 28a remains in the off-state and cannot be switched on.

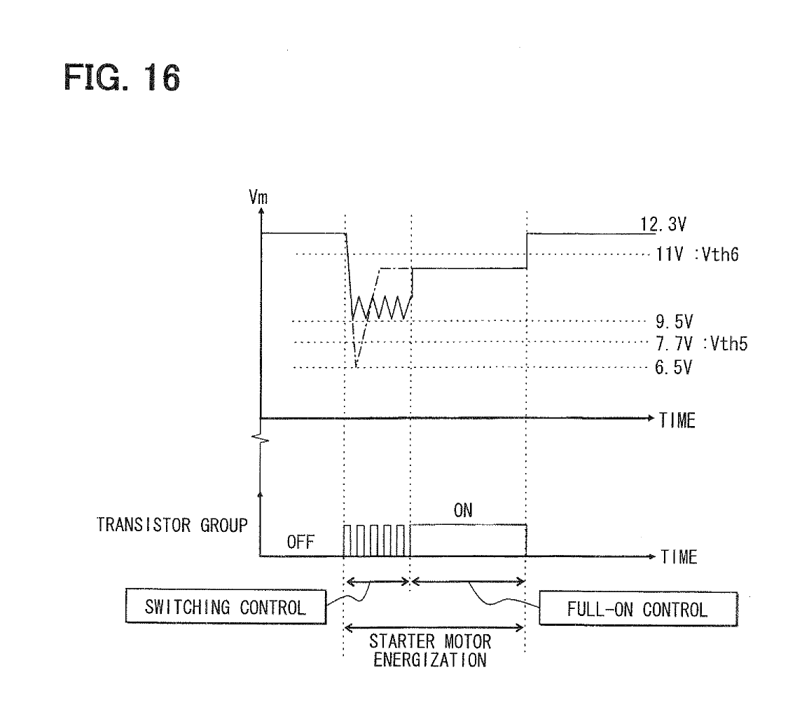

A solid line in an upper part of FIG. 16 shows a waveform of the monitor voltage Vm in the case where the electromagnetic switch 19 and the transistor group 28a are controlled similarly to the case of the solid line in the upper part of FIG. 15 while the pinion gear 21 is disengaged from the ring gear 25. A chained line in the upper part of FIG. 16 shows a waveform of the monitor voltage Vm in the case where the electromagnetic switch 19 and the transistor group 28a are controlled similarly to the case of the chained line in the upper part of FIG. 15 while the pinion gear 21 is disengaged from the ring gear 25.

As understood from FIG. 16, when only the energization to the motor 17 is performed without causing the starter 13 to crank the engine 1 (i.e., when motor 17 is idled away), the motor current decreases by the decrease in the rotation load of the motor 17. Therefore, the monitor voltage Vm at the time when the motor 17 is energized becomes slightly higher than in the case of FIG. 15, in which the cranking is performed.

Accordingly, in the fifth embodiment, the abnormality of the transistor group 28 is detected by processing substantially similar to the first embodiment.

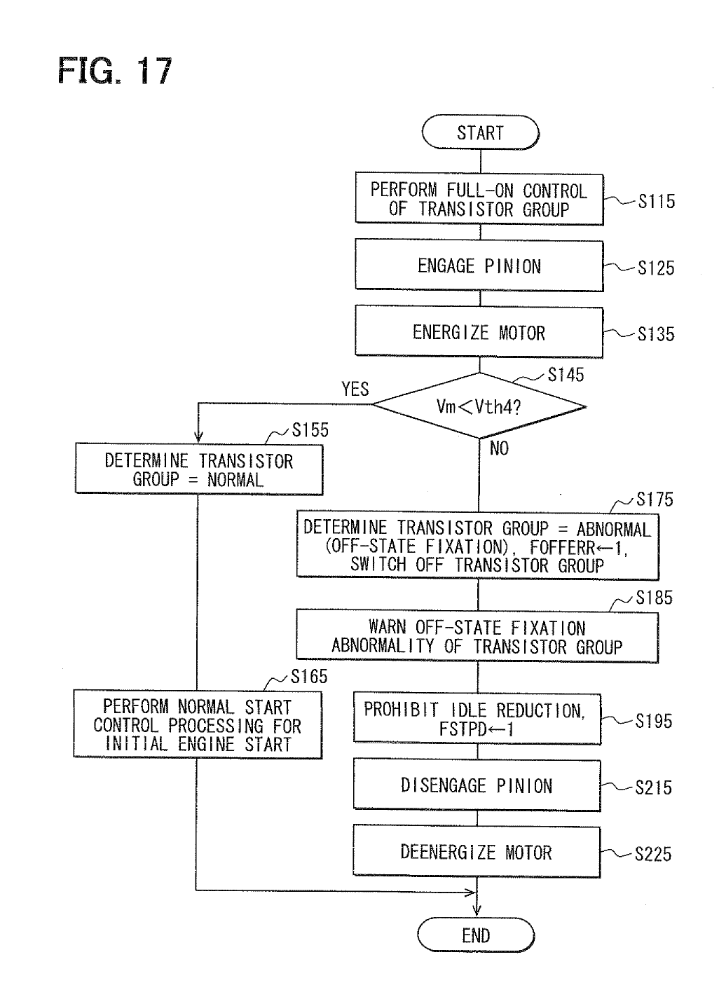

Next, more specific contents of diagnostic processing performed by the microcomputer 41 according to the fifth embodiment will be explained with reference to flowcharts shown in FIGS. 17 to 19.

FIG. 17 is a flowchart showing diagnostic processing at initial start replacing the processing of FIG. 6. Also the diagnostic processing at initial start shown in FIG. 17 is started when the vehicle driver performs the starting operation and the starter signal becomes the active level in the initial start of the engine 1.

As shown in FIG. 17, if the microcomputer 41 starts the diagnostic processing at initial start, the full-on control of the transistor group 28a is performed in S115 first. In following S125, the transistor 52 is switched on to engage the pinion gear 21 with the ring gear 25. In following S135, the transistor 51 is switched on to bring the electromagnetic switch 19 to the on-state, thereby starting the energization to the motor 17. Thus, the current flows to the motor 17 without being suppressed by the transistor group 28a, whereby the cranking of the engine 1 is started.

In following S145, the minimum peak value of the monitor voltage Vm is sensed by performing the ND conversion of the monitor voltage Vm multiple times at predetermined short intervals. It is determined whether the minimum peak value is lower than a predetermined determination value Vth4. If it is determined that the minimum peak value of the monitor voltage Vm is lower than the determination value Vth4 (i.e., when monitor voltage Vm becomes lower than determination value Vth4), it is determined that the transistor group 28a is normal in S155. In following S165, the normal start control processing for initial engine start is performed.

The normal start control processing of S165 is remaining processing for realizing the starter control contents at the initial engine start together with the processing from S115 to S135. It is determined whether the engine 1 has reached the complete explosion state in S165. If it is determined that the complete explosion state has been reached, the transistor group 28a and the transistors 51, 52 are switched off. Thus, the energization to the motor 17 is stopped and the pinion gear 21 is returned to the initial position where the pinion gear 21 is disengaged from the ring gear 25. If such the normal start control ends, the diagnostic processing at initial start also ends.

As shown in FIG. 15, the determination value Vth4 used in S145 is the value slightly lower than the battery voltage VB. For example, the determination value Vth4 is set at 11 V. The normal value of the minimum peak value of the monitor voltage Vm (9.3 V in example of FIG. 15) in the case where the engine 1 is cranked by performing the switching control of the transistor group 28a at the start of the energization to the motor 17 may be defined as Vq1. The normal value of the minimum peak value of the monitor voltage Vm (6.3 V in example of FIG. 15) in the case where the engine 1 is cranked by performing the full-on control of the transistor group 28a at the start of the energization to the motor 17 may be defined as Vq2. In this case, a determination value Vth3 set between Vq1 and Vq2 may be used in S145 in place of the determination value Vth4. The determination value Vth3 is 7.5 V in the example of FIG. 15.

In S145, the A/D conversion of the monitor voltage Vm may be performed once when a time, at which the battery voltage VB is anticipated to minimize, passes from the start of the energization to the motor 17, and the ND conversion value may be used as the minimum peak value of the monitor voltage Vm.

When it is determined that the minimum peak value of the monitor voltage Vm is not lower than the determination value Vth4 (or Vth3) in S145 (i.e., when monitor voltage Vm does not become lower than determination value), it is thought that the transistor group 28a is not switched on. Therefore, in this case, the process proceeds to S175, in which it is determined that the off-state fixation abnormality has occurred in the transistor group 28a. Then, the error flag FOFFERR indicating the occurrence of the off-state fixation abnormality is set at 1 and the transistor group 28a is switched off just to be safe.

In following S185, informing processing for informing the vehicle driver of the occurrence of the off-state fixation abnormality of the transistor group 28a is performed. For example, as the informing processing, a warning lamp (indicator) is lit, a buzzer is set off, or a message is displayed to notify the vehicle driver that the engine 1 cannot be started or that repair is necessary. Further, in following S195, an idle reduction prohibition flag FSTPD for prohibiting the idle reduction is set at 1. Thus, even if the automatic stop condition is established during the operation of the engine 1 thereafter, the idle reduction is no longer performed.

In following S215, the transistor 52 is switched off to return the pinion gear 21 to the initial position. In following S225, the transistor 51 is switched off to bring the electromagnetic switch 19 to the off-state. Then, the diagnostic processing at initial start ends.

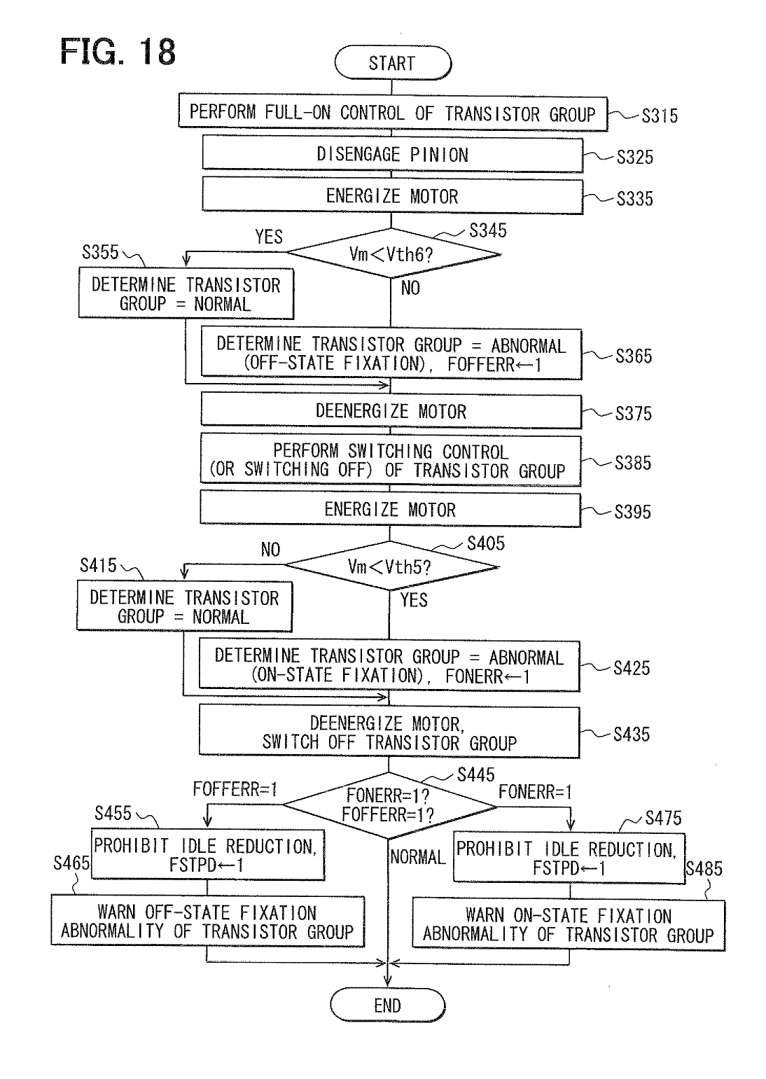

FIG. 18 is a flowchart showing diagnostic processing during engine operation replacing the processing shown in FIG. 8. The diagnostic processing during engine operation shown in FIG. 18 is also performed during the operation of the engine 1 at every constant time interval, for example.

As shown in FIG. 18, if the microcomputer 41 starts the diagnostic processing during engine operation, the full-on control of the transistor group 28a is performed in S315 first. In following S325, the transistor 52 is maintained in the off-state to maintain the pinion gear 21 at the initial position. In following S335, the transistor 51 is switched on to bring the electromagnetic switch 19 to the on-state, thereby starting the energization to the motor 17. Thus, the motor 17 rotates. However, since the pinion gear 21 is at the initial position, the engine 1 is not cranked. That is, the motor 17 is idled away by setting the transistor group 28a in the on-state.

Then, in following S345, the minimum peak value of the monitor voltage Vm is sensed as in S145 of FIG. 17. It is determined whether the minimum peak value is lower than a predetermined determination value Vth6. If it is determined that the minimum peak value of the monitor voltage Vm is lower than the determination value Vth6 (i.e., when monitor voltage Vm becomes lower than determination value Vth6), it is determined that the transistor group 28a is normal in S355, and the process proceeds to S375.

The determination value Vth6 used in S345 is the value slightly lower than the battery voltage VB as shown in FIG. 16. For example, the determination value Vth6 is set at 11 V like the above-mentioned determination value Vth4. The minimum peak value of the monitor voltage Vm (9.5 V in example of FIG. 16) shown by a solid line in an upper part of FIG. 16 may be defined as Vr1. The minimum peak value of the monitor voltage Vm (6.5 V in example of FIG. 16) shown by a chained line in the upper part of FIG. 16 may be defined as Vr2. In this case, a determination value Vth5 set between Vr1 and Vr2 may be used in S345 instead of the determination value Vth6, for example. The determination value Vth5 is slightly higher than the above-mentioned determination value Vth3 and is 7.7 V in the example of FIG. 16.

When it is determined that the minimum peak value of the monitor voltage Vm is not lower than the determination value Vth6 (or Vth5) in S345 (i.e., when monitor voltage Vm does not become lower than determination value), it is thought that the transistor group 28a is not switched on. Therefore, in this case, the process proceeds to S365, in which it is determined that the off-state fixation abnormality has occurred in the transistor group 28a. The error flag FOFFERR indicating the occurrence of the off-state fixation abnormality is set at 1, and the process proceeds to S375.

In S375, the transistor 51 is switched off to switch off the electromagnetic switch 19 once. That is, the energization to the motor 17 is suspended once. In following. S385, the switching control of the transistor group 28a is performed. In following S395, the transistor 51 is switched on to start the energization to the motor 17. That is, the motor 17 is idled away by performing the switching control of the transistor group 28a.

In following S405, the minimum peak value of the monitor voltage Vm is sensed as in S145 of FIG. 17. It is determined whether the minimum peak value is lower than the determination value Vth5. If the minimum peak value of the monitor voltage Vm is not lower than the determination value Vth5 (i.e., if monitor voltage Vm does not become lower than determination value Vth5), it is determined in S415 that the transistor group 28a is normal, and the process proceeds to S435.

The process proceeds to S425 when it is determined that the minimum peak value of the monitor voltage Vm is lower than the determination value Vth5 in S405 (i.e., when monitor voltage Vm becomes lower than determination value Vth5). In S425, it is determined that the on-state fixation abnormality has occurred in the transistor group 28a. The on-state fixation abnormality is a fixation abnormality, in which the transistor group 28a remains in the on-state. An error flag FONERR indicating the occurrence of the on-state fixation abnormality is set at 1, and the process proceeds to S435.

In S385, instead of performing the switching control of the transistor group 28a, the transistor group 28a may be switched off. Also in this case, the on-state fixation abnormality of the transistor group 28a can be detected by the determination of S405.

In S435, the transistor 51 is switched off to switch off the electromagnetic switch 19, and also the transistor group 28a is switched off. In following S445, the abnormality determination of the transistor group 28a is performed. More specifically, both of the error flag FOFFERR and the error flag FONERR are referred to. If both of the error flags FOFFERR, FONERR are 0, the diagnostic processing during engine operation is ended as it is. If the error flag FOFFERR is 1, the process proceeds to S455, in which the idle reduction prohibition flag FSTPD is set at 1. Further, in following S465, the informing processing similar to the processing in S185 of FIG. 17 is performed. Then, the diagnostic processing during engine operation is ended. In S465 of the diagnostic processing during engine operation, it is desirable to provide the vehicle driver with a message (display, sound or the like) for urging the vehicle driver to go to the car dealer or the like without stopping the engine 1. It is because the engine 1 cannot be started with the starter 13 when the off-state fixation abnormality exists in the transistor group 28a.

If the error flag FONERR is 1, the process proceeds to S475, in which the idle reduction prohibition flag FSTPD is set at 1. In following S485, informing processing for informing the vehicle driver of the occurrence of the on-state fixation abnormality of the transistor group 28a is performed. Then, the diagnostic processing during engine operation is ended. As the informing processing in S485, the warning lamp (indicator) is lit, the buzzer is set off, or the message is displayed to urge the vehicle driver to go to the car dealer of the like, for example.

Also during the idle reduction, the microcomputer 41 performs the same processing as the processing of FIG. 18 as diagnostic processing during idle reduction. Also the diagnostic processing during idle reduction may be performed at every constant time interval. The diagnostic processing during idle reduction should be preferably performed at least immediately after the idle reduction is started. Thus, the diagnosis of the transistor group 28a can be performed at least once during the idle reduction regardless of the timing when the automatic start condition is established.

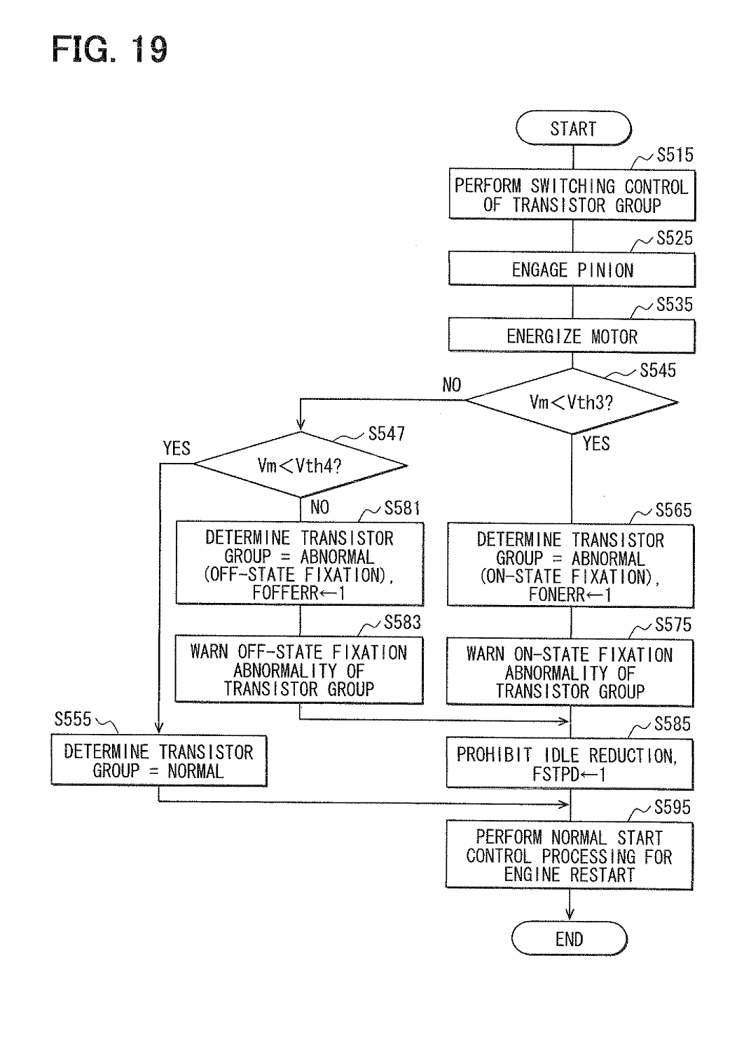

FIG. 19 is a flowchart showing diagnostic processing at restart replacing the processing shown in FIG. 9. Also the diagnostic processing of FIG. 19 is performed at the restart of the engine 1. That is, if the microcomputer 41 determines that the automatic start condition is established during the idle reduction, the microcomputer 41 performs the diagnostic processing at restart.

As shown in FIG. 19, if the microcomputer 41 starts the diagnostic processing at restart, the switching control of the transistor group 28a is performed first in S515. In following S525, the transistor 52 is switched on to engage the pinion gear 21 with the ring gear 25. In following S535, the transistor 51 is switched on to switch on the electromagnetic switch 19, thereby starting the energization to the motor 17. Thus, the engine cranking (i.e., cranking for restart from idle reduction) is started while suppressing the inrush current flowing to the motor 17.

In following S545, the minimum peak value of the monitor voltage Vm is sensed as in S145 of FIG. 17. It is determined whether the minimum peak value is lower than the determination value Vth3. If the minimum peak value of the monitor voltage Vm is not lower than the determination value Vth3 (i.e., if monitor voltage Vm does not become lower than determination value Vth3), the process proceeds to S547.

In S547, it is determined whether the minimum peak value of the monitor voltage Vm is lower than the determination value Vth4 (>Vth3). If the minimum peak value of the monitor voltage Vm is lower than the determination value Vth4 (i.e., if minimum peak value of monitor voltage Vm resides between Vth3 and Vth4), it is determined in S555 that the transistor group 28a is normal, and the process proceeds to S595.

If it is determined that the minimum peak value of the monitor voltage Vm is lower than the determination value Vth3 in S545 (i.e., if monitor voltage Vm becomes lower than determination value Vth3), the process proceeds to S565. In S565, it is determined that the on-state fixation abnormality has occurred in the transistor group 28a. The error flag FONERR indicating the occurrence of the on-state fixation abnormality is set at 1. In following S575, the informing processing similar to the processing in S485 of FIG. 18 is performed. In following S585, the idle reduction prohibition flag FSTPD is set at 1 to prohibit subsequent execution of the idle reduction. Then, the process proceeds to S595.

If it is determined that the minimum peak value of the monitor voltage Vm is not lower than the determination value Vth4 in S547 (i.e., if monitor voltage Vm does not become lower than determination value Vth4), the process proceeds to S581. In S581, it is determined that the off-state fixation abnormality has occurred in the transistor group 28a. The error flag FOFFERR indicating the occurrence of the off-state fixation abnormality is set at 1. In following S583, the informing processing similar to the processing in S185 of FIG. 17 is performed. Then, the process proceeds to S585, in which the idle reduction prohibition flag FSTPD is set at 1. Then, the process proceeds to S595.

In S595, normal start control processing for engine restart is performed. The normal start control processing of S595 is remaining processing for realizing the starter control contents at the engine restart from the idle reduction together with the processing from S515 to S535. Therefore, in S595, first, it is determined whether a predetermined time has elapsed after the energization to the motor 17 is started in S535. If the predetermined time elapses, the transistor group 28a is switched to the full-on control while keeping the transistor 51 in the on-state. It is determined whether the engine 1 has reached the complete explosion state. If it is determined that the complete explosion state is reached, the transistor group 28a and the transistors 51, 52 are switched off. Thus, the energization to the motor 17 is stopped and the pinion gear 21 is returned to the initial position where the pinion gear 21 is disengaged from the ring gear 25. If such the normal start control ends, the diagnostic processing at restart also ends. However, if the off-state fixation abnormality has occurred in the transistor group 28a, the energization to the motor 17 is impossible and therefore the engine 1 cannot be restarted.

With the above-described ECU 11 according to the fifth embodiment, by the processing of FIG. 18 performed during the engine operation and the idle reduction, the off-state fixation abnormality and the on-state fixation abnormality of the transistor group 28a can be detected distinctly before the restart of the engine 1.

Moreover, by the processing of FIG. 17 performed at the initial engine start, the off-state fixation abnormality of the transistor group 28a can be detected without energizing the motor 17 only for the abnormality detection.

Likewise, by the processing of FIG. 19 performed at the restart of the engine 1, the on-state fixation abnormality and the off-state fixation abnormality of the transistor group 28a can be detected without energizing the motor 17 only for the abnormality detection.

When at least either one of the fixation abnormalities of the transistor group 28a is detected, the execution of the idle reduction is prohibited (S195, S455, S475, S585). Therefore, when the on-state fixation abnormality of the transistor group 28a arises, the problem that the inrush current flowing to the motor 17 cannot be suppressed at the restart of the engine 1 so that the battery voltage VB lowers and a certain ECU is reset can be precluded. In addition, when the off-state fixation abnormality of the transistor group 28a arises, the problem that the idle reduction is performed and the engine 1 cannot be restarted can be precluded.

Moreover, when either one of the fixation abnormalities of the transistor group 28a is detected, the occurrence of the abnormality is informed to the vehicle driver (S185, S465, S485, S575, S583). Therefore, early repair can be urged to the vehicle driver.

As for the determination values Vth3, Vth5 for detecting the on-state fixation abnormality, the determination value Vth3 in the case where the cranking is performed and the determination value Vth5 in the case where the motor 17 is idled away are set at the different values. The determination value Vth3 is set at the smaller value than the determination value Vth5. Therefore, the determination accuracy of the on-state fixation abnormality can be improved in the respective cases.

Also in the present embodiment, the fixation abnormality of the transistor group 28a is detected based on the battery voltage VB, monitoring of which is necessary for performing the idle reduction control. Therefore, there is no need to newly add a circuit for monitoring a signal only for the abnormality detection.

The processing of FIG. 18 may be performed during only either one of the engine operation and the idle reduction like the processing of FIG. 8. That is, only either one of the diagnostic processing during engine operation and the diagnostic processing during idle reduction may be performed. It is preferable that the processing of FIG. 18 is performed when the vehicle speed is higher than zero like the processing of FIG. 8.

In the fifth embodiment, the transistor group 28a corresponds to a switching element as an inrush current suppressing section. The processing of S515, S535 and S595 in FIG. 17 corresponds to restart energization processing. The processing of S115, S135 and S165 in FIG. 17 corresponds to initial start energization processing.

Each of the processing of S145, S155 and S175 in FIG. 17, the processing of S315 to S445 in FIG. 18 and the processing of S545 to S565 and S581 in FIG. 19 corresponds to processing as an abnormality detecting section.

In the processing as the abnormality detecting section, the processing of S325 and S385 to S435 in FIG. 18 corresponds to an on-state fixation abnormality detection processing at non-start timing. The processing of S545 and S565 in FIG. 19 corresponds to an on-state fixation abnormality detection processing at restart. The processing of S315 to S375 in FIG. 18 corresponds to off-state fixation abnormality detection processing at non-start timing. The processing of S145, S155 and S175 in FIG. 17 corresponds to off-state fixation abnormality detection processing at initial start.

The determination value Vth5 of S405 corresponds to a first determination value for on-state fixation. The determination value Vth3 of S545 corresponds to a second determination value for on-state fixation. Each of the determination value Vth6 (or Vth5) of S345 and the determination value Vth4 (or Vth3) of S145 corresponds to an off-state fixation determination value.

Each of the processing of S475 in FIG. 18 and the processing of S585 reached from S575 in FIG. 19 corresponds to a first prohibiting section. Each of the processing of S485 in FIG. 18 and the processing of S575 in FIG. 19 corresponds to a first informing section. Each of the processing of S195 in FIG. 17 and the processing of S455 in FIG. 18 corresponds to a second prohibiting section. Each of the processing of S185 in FIG. 17 and the processing of S465 in FIG. 18 corresponds to a second informing section.

The determination values Vth4, Vth6 for detecting the off-state fixation abnormality of the transistor group 28a may be set at voltage(s) lower than a voltage level, to which the voltage falls when the electric load other than the starter motor 17 actuates, and higher than the determination values Vth3, Vth5 for detecting the on-state fixation abnormality. With such the setting, the off-state fixation abnormality of the transistor group 28a can be detected correctly even if the battery voltage VB falls due to the actuation of the electric load other than starter motor 17.

The determination values Vth4, Vth6 may be set variably according to the states of the battery 15, the electric load and the like. Similarly, also the determination values Vth3, Vth5 may be set variably according to the state of the battery 15, the suppression quantity of the inrush current flowing to the motor 17, temperature of the engine 1 or the starter 13 (or motor 17), viscosity or temperature of engine oil, an engine load and the like. The determination values Vth3, Vth5 may be the same value.

### Sixth Embodiment

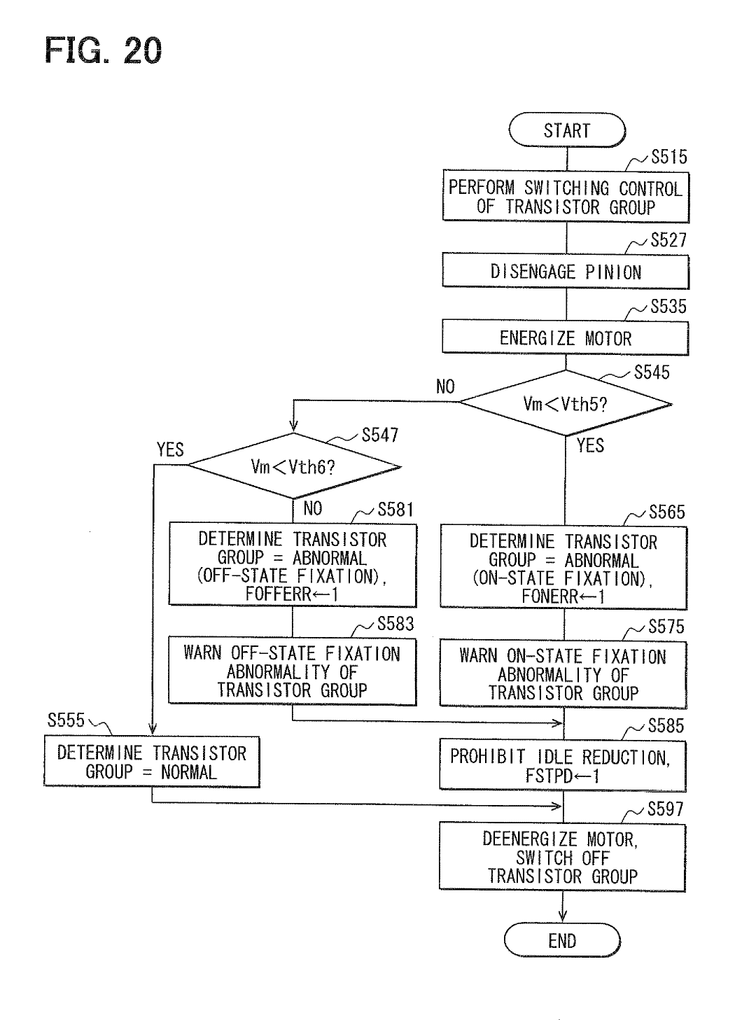

Next, a sixth embodiment of the present invention will be described. The sixth embodiment is different from the fifth embodiment in that the microcomputer 41 of the ECU 11 according to the sixth embodiment performs processing of FIG. 20 in place of the processing of FIG. 18 (diagnostic processing during engine operation, diagnostic processing during idle reduction).

The processing of FIG. 20 differs from the diagnostic processing at restart shorn in FIG. 19 in following points. First, in S527 replacing S525, the transistor 52 is switched off to disengage the pinion gear 21 from the ring gear 25. Thus, the cranking of the engine 1 is prevented.

In S597 replacing S595, the diagnosis has been ended at this time point. Therefore, the transistor 51 is switched off to switch off the electromagnetic switch 19, and also the transistor group 28a is switched off.

The motor 17 is idled away in the processing of FIG. 20. Therefore, in the determination of S545, the determination value Vth5 in the case of idling the motor 17 (refer to FIG. 16) is used in place of the determination value Vth3 (refer to FIG. 15) in the case of performing the cranking. In the determination of S547, the determination value Vth6 (refer to FIG. 16) in the case of idling the motor 17 is used in place of the determination value Vth4 (refer to FIG. 15) in the case of performing the cranking. However, since Vth4=Vth6 in the example of FIGS. 15 and 16, S547 is substantially the same between FIGS. 19 and 20.

Also by performing the processing of FIG. 20 as one or both of the diagnostic processing during engine operation and the diagnostic processing during idle reduction, the off-state fixation abnormality and the on-state fixation abnormality of the transistor group 28a can be detected distinctly before the restart of the engine 1.

It is preferable to perform the processing of FIG. 20 when the vehicle speed is higher than zero since the operation sound of the motor 17 can be made less noticeable.

(First Modification)

In the above-described embodiments, the abnormality of the ICR relay 27 or the transistor group 28a is detected based on the battery voltage VB, which is the voltage of the power supply line upstream of the ICR relay 27 or the transistor group 28a. Alternatively, for example, the abnormality of the ICR relay 27 or the transistor group 28a may be detected based on a voltage Vx of the power supply line between the ICR relay 27 or the transistor group 28a and the electromagnetic switch 19.

Following explanation will be given by using the first embodiment as an example. The current flowing through the motor 17 differs between the case where the ICR relay 27 is on the resistor side and the case where the ICR relay 27 is on the contact side. Therefore, a difference arises also in the voltage Vx. A range of the voltage Vx in the case where the ICR relay 27 is switched to the resistor side and the motor 17 is energized may be defined as a range H1. A range of the voltage Vx in the case where the ICR relay 27 is switched to the contact side and the motor 17 is energized may be defined as a range H2. In this case, the voltage Vx may be monitored and it may be determined that the resistor side fixation abnormality has occurred in the ICR relay 27 if it is determined that the voltage Vx is outside the range H2 or the voltage Vx is inside the range H1 in S140 of FIGS. 6 and S340 of FIG. 8 respectively. In addition, the voltage Vx may be monitored and it may be determined that the contact side fixation abnormality has occurred in the ICR relay 27 if it is determined that the voltage Vx is outside the range H1 or the voltage Vx is inside the range H2 in S400 of FIGS. 8 and S540 of FIG. 9 respectively. Such the modification can be applied also to the abnormality detection of the transistor group 28a in a similar way.

(Second Modification)

In the above-described embodiments, the abnormality is detected based on the value of the voltage. Alternatively, the abnormality may be detected by using change speed of the voltage.

Next, a second modification will be explained as a modification of the first embodiment.

As shown in FIG. 4, the change speed (speed of fall in this case) of the battery voltage (shown by chained line) in the case where the ICR relay 27 is switched to the resistor side and the motor 17 is energized is lower than the change speed of the battery voltage (shown by solid line) in the case where the ICR relay 27 is switched to the contact side and the motor 17 is energized.

Therefore, a threshold value (of change speed of voltage) for the abnormality detection of the ICR relay 27 is set at a value larger than change speed, which is anticipated when the ICR relay 27 is on the resistor side, and smaller than change speed, which is anticipated when the ICR relay 27 is on the contact side. That is, the threshold value is set between the change speed in the case of the resistor side and the change speed in the case of the contact side.

In S540 of FIG. 9 as the diagnostic processing at engine restart, the change speed (speed of fall) of the monitor voltage Vm since the energization to the motor 17 is started until the monitor voltage Vm reaches the minimum peak is sensed. The sensed change speed is compared with the above-described threshold value. If the change speed of the monitor voltage Vm is equal to or higher than the threshold value, it is determined that the contact side fixation abnormality has occurred in the ICR relay 27.

Also in S140 of FIG. 6 as the diagnostic processing at initial engine start, the change speed (speed of fall) of the monitor voltage Vm since the energization to the motor 17 is started until the monitor voltage Vm reaches the minimum peak is sensed. The sensed change speed is compared with the above-described threshold value. If the change speed of the monitor voltage Vm is lower than the threshold value, it is determined that the resistor side fixation abnormality has occurred in the ICR relay 27.

(Other Modifications)

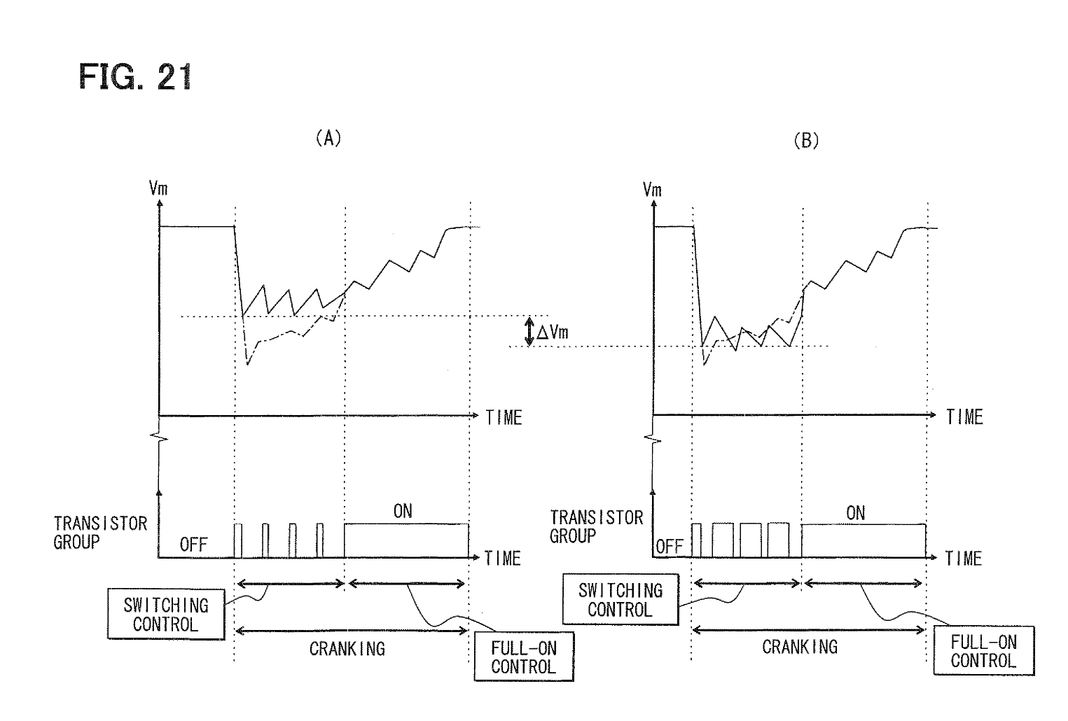

In the case where the current to the motor 17 during the cranking is suppressed by the switching control of the transistor group 28a as in the fifth embodiment, the degree of the suppression of the current to the motor 17 (i.e., current suppression quantity) can be changed by changing a duty ratio of the switching control as shown in FIG. 21. In this example, the duty ratio is a ratio of an on-state time to a single cycle time, which is sum of the on-state time and an off-state time.

Part (A) of FIG. 21 shows an example of further suppressing the fall of the battery voltage by decreasing the duty ratio and thus increasing the suppression quantity of the inrush current to the motor 17 during an inrush current suppression period, in which the switching control of the transistor group 28a is performed. Part (B) of FIG. 21 shows an example of decreasing the suppression quantity of the inrush current to the motor 17 by increasing the duty ratio during the inrush current suppression period. A chained line in each of parts (A) and (B) of FIG. 21 shows a voltage waveform in the case where the full-on control of the transistor group 28a is performed from the beginning of the energization to the motor 17 like the chained line in FIG. 15.

The full-on control of the transistor group 28a according to the above embodiment may include control for almost keeping the transistor group 28a in the on-state. That is, the duty ratio for the full-on control is not limited to 100%. Alternatively, the full-on control may be performed by setting the duty ratio at a value close to 100%.

Further, adjustment according to a charged state (i.e., charge amount) of the battery 15 may be performed to further suppress the fall of the battery voltage by increasing the suppression quantity of the inrush current (i.e., by decreasing duty ratio) when the charge amount is small or to improve startability of the engine 1 by decreasing the suppression quantity of the inrush current when the charge amount is large, for example.

The present invention is not limited to the above-described embodiments and modifications. Furthermore, the present invention can be modified and implemented as follows, for example.

For example, the electromagnetic switch 19 may be driven directly, not via the relay 31. Likewise, the pinion actuation solenoid 23 may be driven directly, not via the relay 33.

The ICR relay 27 may be structured to be switched to the contact side (such that contacts 27b, 27c short-circuit) when the coil 27a is energized. The ICR relay 27 may be arranged in the power supply line between the electromagnetic switch 19 and the motor 17.

In the above-described first embodiment, the determination value for determining the resistor-side fixation abnormality and the determination value for determining the contact-side fixation abnormality are set at the same value. Alternatively, the determination values may be set at different values. That is, the determination value VthcR used in S140 of FIG. 6 and the determination value VthcP used in S540 of FIG. 9 may be set at different values. Likewise, the determination value VthiR used in S340 of FIG. 8 and the determination value VthiP used in S400 of FIG. 8 may be set at different values.

A microcomputer different from the microcomputer 41 or an ECU different from the ECU 11 may have the function as the idle reduction controlling section. For example, in the latter case, in the first embodiment, the ECU different from the ECU 11 may determine whether the automatic stop condition is established during the engine operation. If the different ECU determines that the automatic stop condition is established, the different ECU may automatically stop the engine 1 and inform the ECU 11 of state information indicating the occurrence of the idle reduction state. Then, the different ECU may determine whether the automatic start condition is established. If the different ECU determines that the automatic start condition is established, the different ECU may output an engine restart command to the ECU 11. The microcomputer 41 of the ECU 11 may determine whether the engine operation is being performed or the idle reduction is being performed based on the above-described state information and may perform the processing of FIG. 8. If the microcomputer 41 receives the restart command, the microcomputer 41 may perform the processing of FIG. 9.

An ECU different from the ECU 11 may have the function as the idle reduction controlling section and the control function of the engine 1 (injection, blockage of intake air supply route). That is, the ECU 11 may be constructed such that the ECU 11 performs the abnormality detection of the ICR relay 27 or the transistor group 28a and drives the starter 13 but does not perform the determination about the necessity of the idle reduction and the engine control.

The processing of FIG. 8, 18 or 20 may be performed when an automatic stop condition of a preceding vehicle having an idle reduction function is established by using inter-vehicle communication or road-to-vehicle communication. In this case, a frequency of the processing can be reduced as compared to the case where the processing of FIG. 8, 18 or 20 is performed at every constant time interval during the engine operation.

The processing of FIG. 8, 18 or 20 may be performed when it is anticipated that the own vehicle stops for a predetermined time or longer based on information about a traffic signal or a rail crossing in front of the vehicle, the information being obtained by the road-to-vehicle communication.

The processing of FIG. 8, 18 or 20 may be suspended based on a circumference environment of the vehicle (e.g., whether vehicle is in residential area or not, whether noise level is high or not) or time (night or day). It is preferable not to perform the processing of FIG. 8, 18 or 20 when the occupant prohibits the idle reduction by a switch or the like.

The processing of FIG. 8, 18 or 20 may be performed only when the automatic stop condition is established. In this case, the driver can be noticed of the possibility that the idle reduction will be performed soon by the operation sound of the motor 17 accompanying the processing of FIG. 8, 18 or 20.

For details of the starter, U.S. patent application Ser. No. 12/461,327 (publication No. 2010/0033066 A1) or US patent application publication No. 2008/0127927 A1 may be referred to, for example.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A starter controller used for a vehicle having:
a starter that cranks an engine of the vehicle by torque of a motor;
switching means that is provided in a power supply line from a power supply to the motor of the starter and that is selectively driven between an on-state for connecting the power supply line and an off-state for disconnecting the power supply line;
inrush current suppressing means that is provided in series with the switching means in the power supply line and that is driven between a first state for suppressing a current passed to the motor and a second state for not suppressing the current passed to the motor; and
idle reduction controlling means for stopping the engine when a predetermined automatic stop condition is satisfied and for restarting the engine when a predetermined automatic start condition is satisfied thereafter, the starter controller comprising:
restart energization processing means for performing restart energization processing for driving the inrush current suppressing means to the first state, for driving the switching means to the on-state, and for driving the inrush current suppressing means from the first state to the second state after elapse of a predetermined time as energization processing for energizing the motor such that the starter cranks the engine when the idle reduction controlling means restarts the engine; and
abnormality detecting means for detecting whether an uncontrollable abnormality occurs in the inrush current suppressing means based on a voltage of the power supply line at the time when the switching means is driven to the on-state.

2. The starter controller as in claim 1, wherein
the inrush current suppressing means is selectively driven between the first state where a resistor is inserted into the power supply line in series and the second state where the resistor is not inserted into the power supply line.

3. The starter controller as in claim 2, wherein
the abnormality detecting means detects whether a fixation abnormality, in which the inrush current suppressing means cannot switch the state, occurs in the inrush current suppressing means based on an output voltage of the power supply at the time when the switching means is driven to the on-state.

4. The starter controller as in claim 3, wherein
the abnormality detecting means determines whether the output voltage of the power supply becomes lower than a predetermined second state fixation determination value when the inrush current suppressing means is driven to the first state and the switching means is driven to the on-state, and
the abnormality detecting means determines that a fixation abnormality, in which the inrush current suppressing means remains in the second state, occurs in the inrush current suppressing means if the output voltage becomes lower than the second state fixation determination value.

5. The starter controller as in claim 4, wherein
the starter has a pinion gear that is rotated by the motor and that cranks the engine when the pinion gear is rotated in a state where the pinion gear is engaged with a ring gear of the engine,
the starter is constructed to be able to switch between a state where the pinion gear is engaged with the ring gear and a state where the pinion gear is disengaged from the ring gear regardless of whether the motor is energized or not, and
the abnormality detecting means performs second state fixation abnormality detection processing at non-start timing for disengaging the pinion gear from the ring gear, for driving the inrush current suppressing means to the first state, for driving the switching means to the on-state, for determining whether the output voltage of the power supply at that time becomes lower than a first determination value for second state fixation, and for determining that the fixation abnormality, in which the inrush current suppressing means remains in the second state, occurs in the inrush current suppressing means if the output voltage becomes lower than the first determination value for second state fixation as processing for detecting whether the fixation abnormality, in which the inrush current suppressing means remains in the second state, occurs in the inrush current suppressing means during one or both of an operation of the engine, which is before the idle reduction controlling means stops the engine, and idle reduction, which extends since the idle reduction controlling means stops the engine until the idle reduction controlling means restarts the engine.

6. The starter controller as in claim 4, wherein
the abnormality detecting means performs second state fixation abnormality detection processing at restart for determining whether the output voltage of the power supply becomes lower than a second determination value for second state fixation and for determining that the fixation abnormality, in which the inrush current suppressing means remains in the second state, occurs in the inrush current suppressing means if the output voltage becomes lower than the second determination value for second state fixation as the processing for detecting whether the fixation abnormality, in which the inrush current suppressing means remains in the second state, occurs in the inrush current suppressing means when the starter controller performs the restart energization processing to drive the inrush current suppressing means to the first state and to drive the switching means to the on-state.

7. The starter controller as in claim 4, further comprising:
first prohibiting means for prohibiting the idle reduction controlling means from stopping the engine when the abnormality detecting means determines that the fixation abnormality, in which the inrush current suppressing means remains in the second state, occurs in the inrush current suppressing means.

8. The starter controller as in claim 4, further comprising:
first informing means for informing a vehicle driver of the occurrence of the fixation abnormality, in which the inrush current suppressing means remains in the second state, when the abnormality detecting means determines that the fixation abnormality, in which the inrush current suppressing means remains in the second state, occurs in the inrush current suppressing means.

9. The starter controller as in claim 3, wherein
the abnormality detecting means determines whether the output voltage of the power supply becomes lower than a predetermined first state fixation determination value when the inrush current suppressing means is driven to the second state and the switching means is driven to the on-state, and
the abnormality detecting means determines that a fixation abnormality, in which the inrush current suppressing means remains in the first state, occurs in the inrush current suppressing means if the output voltage does not become lower than the first state fixation determination value.

10. The starter controller as in claim 9, wherein
the starter has a pinion gear that is rotated by the motor and that cranks the engine when the pinion gear is rotated in a state where the pinion gear is engaged with a ring gear of the engine,
the starter is constructed to be able to switch between a state where the pinion gear is engaged with the ring gear and a state where the pinion gear is disengaged from the ring gear regardless of whether the motor is energized or not, and
the abnormality detecting means performs first state fixation abnormality detection processing at non-start timing for disengaging the pinion gear from the ring gear, for driving the inrush current suppressing means to the second state, for driving the switching means to the on-state, for determining whether the output voltage of the power supply at that time becomes lower than a first determination value for first state fixation, and for determining that the fixation abnormality, in which the inrush current suppressing means remains in the first state, occurs in the inrush current suppressing means if the output voltage does not become lower than the first determination value for first state fixation as processing for detecting whether the fixation abnormality, in which the inrush current suppressing means remains in the first state, occurs in the inrush current suppressing means during one or both of the operation of the engine, which is before the idle reduction controlling means stops the engine, and the idle reduction, which extends since the idle reduction controlling means stops the engine until the idle reduction controlling means restarts the engine.

11. The starter controller as in claim 9, wherein
the starter controller performs initial start energization processing for driving the inrush current suppressing means to the second state and for driving the switching means to the on-state as energization processing for energizing the motor such that the starter cranks the engine when the starter controller starts the engine in response to a starting operation by a vehicle driver, and
the abnormality detecting means performs first state fixation abnormality detection processing at initial start for determining whether the output voltage of the power supply becomes lower than a second determination value for first state fixation and for determining that the fixation abnormality, in which the inrush current suppressing means remains in the first state, occurs in the inrush current suppressing means if the output voltage does not become lower than the second determination value for first state fixation as processing for detecting whether the fixation abnormality, in which the inrush current suppressing means remains in the first state, occurs in the inrush current suppressing means when the starter controller performs the initial start energization processing.

12. The starter controller as in claim 11, wherein
if the abnormality detecting means determines that the fixation abnormality, in which the inrush current suppressing means remains in the first state, occurs in the inrush current suppressing means when the starter controller performs the initial start energization processing, the abnormality detecting means restricts an energization time of the energization to the motor in present initial start energization processing to a predetermined time.

13. The starter controller as in claim 9, further comprising:
second prohibiting means for prohibiting the idle reduction controlling means from stopping the engine when the abnormality detecting means determines that the fixation abnormality, in which the inrush current suppressing means remains in the first state, occurs in the inrush current suppressing means.

14. The starter controller as in claim 9, further comprising:
second informing means for informing a vehicle driver of the occurrence of the fixation abnormality, in which the inrush current suppressing means remains in the first state, when the abnormality detecting means determines that the fixation abnormality, in which the inrush current suppressing means remains in the first state, occurs in the inrush current suppressing means.

15. The starter controller as in claim 5, wherein
the starter controller engages the pinion gear with the ring gear when the starter controller energizes the motor by the restart energization processing,
the abnormality detecting means performs second state fixation abnormality detection processing at restart for determining whether the output voltage of the power supply becomes lower than a second determination value for second state fixation and for determining that the fixation abnormality, in which the inrush current suppressing means remains in the second state, occurs in the inrush current suppressing means if the output voltage becomes lower than the second determination value for second state fixation as processing for detecting whether the fixation abnormality, in which the inrush current suppressing means remains in the second state, occurs in the inrush current suppressing means when the starter controller performs the restart energization processing to drive the inrush current suppressing means to the first state and to drive the switching means to the on-state, and
the second determination value for second state fixation is set at a value smaller than the first determination value for second state fixation.

16. The starter controller as in claim 10, wherein
the starter controller performs initial start energization processing for driving the inrush current suppressing means to the second state and for driving the switching means to the on-state as energization processing for engaging the pinion gear with the ring gear and for energizing the motor such that the starter cranks the engine when the starter controller starts the engine in response to a starting operation by a vehicle driver,
the abnormality detecting means performs first state fixation abnormality detection processing at initial start for determining whether the output voltage of the power supply becomes lower than a second determination value for first state fixation and for determining that the fixation abnormality, in which the inrush current suppressing means remains in the first state, occurs in the inrush current suppressing means if the output voltage does not become lower than the second determination value for first state fixation as processing for detecting whether the fixation abnormality, in which the inrush current suppressing means remains in the first state, occurs in the inrush current suppressing means when the starter controller performs the initial start energization processing, and
the second determination value for first state fixation is set at a value smaller than the first determination value for first state fixation.

17. The starter controller as in claim 5, wherein
the abnormality detecting means performs the second state fixation abnormality detection processing at non-start timing when running speed of the vehicle is higher than zero.

18. The starter controller as in claim 10, wherein
the abnormality detecting means performs the first state fixation abnormality detection processing at non-start timing when running speed of the vehicle is higher than zero.

19. The starter controller as in claim 1, wherein
the inrush current suppressing means is a switching element provided in the power supply line,
the switching element is brought to the first state when drive of switching control to switch the switching element alternately between an on-state and an off-state is performed, and
the switching element is brought to the second state when drive to continue the on-state is performed.

20. The starter controller as in claim 19, wherein
the abnormality detecting means detects whether an uncontrollable abnormality occurs in the inrush current suppressing means based on the output voltage of the power supply at the time when the switching means is driven to the on-state.

21. The starter controller as in claim 20, wherein
the abnormality detecting means determines whether the output voltage of the power supply becomes lower than a predetermined on-state fixation determination value when the inrush current suppressing means is driven to the first state or the off-state and the switching means is driven to the on-state, and
the abnormality detecting means determines that the fixation abnormality, in which the inrush current suppressing means remains in the on-state, occurs in the inrush current suppressing means if the output voltage becomes lower than the on-state fixation determination value.

22. The starter controller as in claim 21, wherein
the starter has a pinion gear that is rotated by the motor and that cranks the engine when the pinion gear is rotated in a state where the pinion gear is engaged with a ring gear of the engine,
the starter is constructed to be able to switch between a state where the pinion gear is engaged with the ring gear and a state where the pinion gear is disengaged from the ring gear regardless of whether the motor is energized or not,
the abnormality detecting means performs on-state fixation abnormality detection processing at non-start timing for disengaging the pinion gear from the ring gear, for driving the inrush current suppressing means to the first state or the off-state, for driving the switching means to the on-state, for determining whether the output voltage of the power supply at that time becomes lower than a first determination value for on-state fixation, and for determining that the fixation abnormality, in which the inrush current suppressing means remains in the on-state, occurs in the inrush current suppressing means if the output voltage becomes lower than the first determination value for on-state fixation as processing for detecting whether the fixation abnormality, in which the inrush current suppressing means remains in the on-state, occurs in the inrush current suppressing means during one or both of the operation of the engine, which is before the idle reduction controlling means stops the engine, and the idle reduction, which extends since the idle reduction controlling means stops the engine until the idle reduction controlling means restarts the engine.

23. The starter controller as in claim 21, wherein
the abnormality detecting means performs on-state fixation abnormality detection processing at restart for determining whether the output voltage of the power supply becomes lower than a second determination value for on-state fixation and for determining that the fixation abnormality, in which the inrush current suppressing means remains in the on-state, occurs in the inrush current suppressing means if the output voltage becomes lower than the second determination value for on-state fixation as processing for detecting whether the fixation abnormality, in which the inrush current suppressing means remains in the on-state, occurs in the inrush current suppressing means when the starter controller performs the restart energization processing to drive the inrush current suppressing means to the first state and to drive the switching means to the on-state.

24. The starter controller as in claim 21, further comprising:
first prohibiting means for prohibiting the idle reduction controlling means from stopping the engine when the abnormality detecting means determines that the fixation abnormality, in which the inrush current suppressing means remains in the on-state, occurs in the inrush current suppressing means.

25. The starter controller as in claim 21, further comprising:
first informing means for informing a vehicle driver of the occurrence of the fixation abnormality, in which the inrush current suppressing means remains in the on-state, when the abnormality detecting means determines that the fixation abnormality, in which the inrush current suppressing means remains in the on-state, occurs in the inrush current suppressing means.

26. The starter controller as in claim 20, wherein
the abnormality detecting means determines whether the output voltage of the power supply becomes lower than a predetermined off-state fixation determination value when the inrush current suppressing means is driven to the second state and the switching means is driven to the on-state, and
the abnormality detecting means determines that the fixation abnormality, in which the inrush current suppressing means remains in the off-state, occurs in the inrush current suppressing means if the output voltage does not become lower than the off-state fixation determination value.

27. The starter controller as in claim 26, wherein
the starter has a pinion gear that is rotated by the motor and that cranks the engine when the pinion gear is rotated in a state where the pinion gear is engaged with a ring gear of the engine,
the starter is constructed to be able to switch between a state where the pinion gear is engaged with the ring gear and a state where the pinion gear is disengaged from the ring gear regardless of whether the motor is energized or not, and
the abnormality detecting means performs off-state fixation abnormality detection processing at non-start timing for disengaging the pinion gear from the ring gear, for driving the inrush current suppressing means to the second state, for driving the switching means to the on-state, for determining whether the output voltage of the power supply at that time becomes lower than the off-state fixation determination value, and for determining that the fixation abnormality, in which the inrush current suppressing means remains in the off-state, occurs in the inrush current suppressing means if the output voltage does not become lower than the off-state fixation determination value as processing for detecting whether the fixation abnormality, in which the inrush current suppressing means remains in the off-state, occurs in the inrush current suppressing means during one or both of the operation of the engine, which is before the idle reduction controlling means stops the engine, and the idle reduction, which extends since the idle reduction controlling means stops the engine until the idle reduction controlling means restarts the engine.

28. The starter controller as in claim 26, wherein
the starter controller performs initial start energization processing for driving the inrush current suppressing means to the second state and for driving the switching means to the on-state as energization processing for energizing the motor such that the starter cranks the engine when the starter controller starts the engine in response to a starting operation by a vehicle driver, and
the abnormality detecting means performs off-state fixation abnormality detection processing at initial start for determining whether the output voltage of the power supply becomes lower than the off-state fixation determination value and for determining that the fixation abnormality, in which the inrush current suppressing means remains in the off-state, occurs in the inrush current suppressing means if the output voltage does not become lower than the off-state fixation determination value as processing for detecting whether the fixation abnormality, in which the inrush current suppressing means remains in the off-state, occurs in the inrush current suppressing means when the starter controller performs the initial start energization processing.

29. The starter controller as in claim 26, further comprising:
second prohibiting means for prohibiting the idle reduction controlling means from stopping the engine when the abnormality detecting means determines that the fixation abnormality, in which the inrush current suppressing means remains in the off-state, occurs in the inrush current suppressing means.

30. The starter controller as in claim 26, further comprising:
second informing means for informing a vehicle driver of the occurrence of the fixation abnormality, in which the inrush current suppressing means remains in the off-state, when the abnormality detecting means determines that the fixation abnormality, in which the inrush current suppressing means remains in the off-state, occurs in the inrush current suppressing means.

31. The starter controller as in claim 22, wherein
the starter controller engages the pinion gear with the ring gear when the starter controller energizes the motor by the restart energization processing,
the abnormality detecting means performs on-state fixation abnormality detection processing at restart for determining whether the output voltage of the power supply becomes lower than a second determination value for on-state fixation and for determining that the fixation abnormality, in which the inrush current suppressing means remains in the on-state, occurs in the inrush current suppressing means if the output voltage becomes lower than the second determination value for on-state fixation as the processing for detecting whether the fixation abnormality, in which the inrush current suppressing means remains in the on-state, occurs in the inrush current suppressing means when the starter controller performs the restart energization processing to drive the inrush current suppressing means to the first state and to drive the switching means to the on-state, and
the second determination value for on-state fixation is set at a value smaller than the first determination value for on-state fixation.

32. The starter controller as in claim 22, wherein
the abnormality detecting means performs the on-state fixation abnormality detection processing at non-start timing when running speed of the vehicle is higher than zero.

33. The starter controller as in claim 27, wherein
the abnormality detecting means performs the off-state fixation abnormality detection processing at non-start timing when running speed of the vehicle is higher than zero.

34. The starter controller as in claim 20, wherein
the abnormality detecting means monitors the output voltage of the power supply when the starter controller performs the restart energization processing to drive the inrush current suppressing means to the first state and to drive the switching means to the on-state,
the abnormality detecting means determines that the fixation abnormality, in which the inrush current suppressing means remains in the on-state, occurs in the inrush current suppressing means if the monitored output voltage becomes lower than a predetermined on-state fixation determination value, and
the abnormality detecting means determines that the fixation abnormality, in which the inrush current suppressing means remains in the off-state, occurs in the inrush current suppressing means if the monitored output voltage does not become lower than an off-state fixation determination value higher than the on-state fixation determination value.

35. The starter controller as in claim 20, wherein
the starter has a pinion gear that is rotated by the motor and that cranks the engine when the pinion gear is rotated in a state where the pinion gear is engaged with a ring gear of the engine,
the starter is constructed to be able to switch between a state where the pinion gear is engaged with the ring gear and a state where the pinion gear is disengaged from the ring gear regardless of whether the motor is energized or not,
the abnormality detecting means disengages the pinion gear from the ring gear, drives the inrush current suppressing means to the first state, drives the switching means to the on-state, and monitors the output voltage of the power supply at that time during one or both of the operation of the engine, which is before the idle reduction controlling means stops the engine, and the idle reduction, which extends since the idle reduction controlling means stops the engine until the idle reduction controlling means restarts the engine,
the abnormality detecting means determines that the fixation abnormality, in which the inrush current suppressing means remains in the on-state, occurs in the inrush current suppressing means if the monitored output voltage becomes lower than a predetermined on-state fixation determination value, and
the abnormality detecting means determines that the fixation abnormality, in which the inrush current suppressing means remains in the off-state, occurs in the inrush current suppressing means if the monitored output voltage does not become lower than an off-state fixation determination value higher than the on-state fixation determination value.

36. The starter controller as in claim 3, wherein
the abnormality detecting means senses change speed of the output voltage at the time when the starter controller performs the restart energization processing to drive the inrush current suppressing means to the first state and to drive the switching means to the on-state, and
the abnormality detecting means determines that the fixation abnormality, in which the inrush current suppressing means remains in the second state, occurs in the inrush current suppressing means if the change speed is equal to or higher than a predetermined value.

37. The starter controller as in claim 3, wherein
the starter controller performs initial start energization processing for driving the inrush current suppressing means to the second state and for driving the switching means to the on-state as energization processing for energizing the motor such that the starter cranks the engine when the starter controller starts the engine in response to a starting operation by a vehicle driver,
the abnormality detecting means senses change speed of the output voltage at the time when the starter controller performs the initial start energization processing to drive the inrush current suppressing means to the second state and to drive the switching means to the on-state, and
the abnormality detecting means determines that the fixation abnormality, in which the inrush current suppressing means remains in the first state, occurs in the inrush current suppressing means when the change speed is lower than a predetermined value.

38. A starter controller used for a vehicle having:
a starter that cranks an engine of the vehicle by torque of a motor;
a switch that is provided in a power supply line from a power supply to the motor of the starter and that is selectively driven between an on-state for connecting the power supply line and an off-state for disconnecting the power supply line;
an inrush current suppressor that is provided in series with the switch in the power supply line and that is driven between a first state where a suppressing degree of a current passed to the motor is relatively high and a second state where the suppressing degree of the current passed to the motor is relatively low; and
an idle reduction controller that is adapted to output a command to stop the engine when a predetermined automatic stop condition is satisfied and to output a command to restart the engine when a predetermined automatic start condition is satisfied thereafter, wherein
the starter controller is electrically connected with the inrush current suppressor and the switch, and
the starter controller is adapted to perform restart energization processing for outputting a command to drive the inrush current suppressor to the first state, for outputting a command to drive the switch to the on-state, and for outputting a command to drive the inrush current suppressor from the first state to the second state after elapse of a predetermined time as energization processing for energizing the motor such that the starter cranks the engine when the idle reduction controller restarts the engine, the starter controller comprising:
a detector that is electrically connected with the power supply line and that detects whether an uncontrollable abnormality occurs in the inrush current suppressor based on a voltage of the power supply line at the time when the switch is driven to the on-state.

39. An idle reduction system comprising:
a starter that cranks an engine of a vehicle by torque of a motor;
a switch that is provided in a power supply line from a power supply to the motor of the starter and that is selectively driven between an on-state for connecting the power supply line and an off-state for disconnecting the power supply line;
an inrush current suppressor that is provided in series with the switch in the power supply line and that is driven between a first state for suppressing a current passed to the motor and a second state for not suppressing the current passed to the motor;
an idle reduction controller that is adapted to output a command to stop the engine when a predetermined automatic stop condition is satisfied and to output a command to restart the engine when a predetermined automatic start condition is satisfied thereafter; and
a starter controller that is electrically connected with the inrush current suppressor and the switch and that is adapted to drive the inrush current suppressor to the first state, to drive the switch to the on-state, and to drive the inrush current suppressor from the first state to the second state after elapse of a predetermined time as energization processing for energizing the motor such that the starter cranks the engine when the idle reduction controller restarts the engine, wherein
the starter controller is adapted to determine whether an uncontrollable abnormality occurs in the inrush current suppressor based on a voltage of the power supply line during the energization processing.

40. A starter controller used for a vehicle having:
a starter that cranks an engine of the vehicle by torque of a motor;
a switch that is provided in a power supply line from a power supply to the motor of the starter and that is selectively driven between an on-state for connecting the power supply line and an off-state for disconnecting the power supply line; and
an inrush current suppressor that is provided in series with the switch in the power supply line and that is driven between a first state for suppressing a current passed to the motor and a second state for not suppressing the current passed to the motor, wherein
the starter controller is electrically connected with the inrush current suppressor, the switch and the power supply line,
the starter controller is adapted to output a command to drive the inrush current suppressor to the first state, to output a command to drive the switch to the on-state, and to output a command to drive the inrush current suppressor from the first state to the second state after elapse of a predetermined time in order to cause the starter to crank the engine when the starter controller starts or restarts the engine, and
the starter controller is adapted to determine whether an uncontrollable abnormality occurs in the inrush current suppressor based on a voltage of the power supply line at the time when the switch is in the on-state.

41. A medium storing execution commands for operating a controller connected to a starter that cranks an engine of a vehicle with torque of a motor, the medium comprising:
a first state command for driving an inrush current suppressor to a first state, wherein the inrush current suppressor is provided in series with a switch in a power supply line from a power supply to the motor of the starter, wherein the inrush current suppressor is driven between the first state for suppressing a current passed to the motor and a second state for not suppressing the current passed to the motor, and wherein the switch is provided in the power supply line and is selectively driven between an on-state for connecting the power supply line and an off-state for disconnecting the power supply line;
an energization command for connecting the power supply line from the power supply to the motor of the starter;
a second state command for bringing the inrush current suppressor from the first state to the second state when a predetermined time elapses; and
a determination command for determining whether an uncontrollable abnormality occurs in the inrush current suppressor based on a voltage of the power supply line while the energization command is outputted.

42. An abnormality determination method for determining an abnormality in an inrush current suppressor that is provided in series with a switch in a power supply line from a power supply to a motor of a starter of an engine and that is driven between a first state for suppressing a current passed to the motor and a second state for not suppressing the current passed to the motor, wherein the switch is provided in the power supply line and is selectively driven between an on-state for connecting the power supply line and an off-state for disconnecting the power supply line, the method comprising the steps of:
driving the inrush current suppressor to the first state, driving the switch to the on-state, and driving the inrush current suppressor from the first state to the second state after elapse of a predetermined time as energization processing for energizing the motor such that the starter cranks the engine when the engine is started or restarted; and
detecting whether an uncontrollable abnormality occurs in the inrush current suppressor based on a voltage of the power supply line at the time when the switch is driven to the on-state.
